(19) United States
(12) Patent Application Publication
(10) Pub. No.: US 2026/0007153 A1
(43) Pub. Date: Jan. 8, 2026

(54) ZERO SUGAR STABLE FOAM BEVERAGE

(71) Applicant: PepsiCo, Inc., Purchase, NY (US)

(72) Inventors: George MEYER, White Plains, NY (US); Yuan FANG, Cortlandt Manor, NY (US); Shalaka APTE, Purchase, NY (US); Kristi-Ann BOLES, Purchase, NY (US); Danielle BARBARO, Riverdale, NJ (US); Paul SHERIDAN, Purchase, NY (US); Damian BROWNE, Old Greenwich, CT (US)

(21) Appl. No.: 18/763,715

(22) Filed: Jul. 3, 2024

(51) Int. Cl. A23L 2/54; A23L 2/56; A23L 2/60; A23L 2/68

(52) U.S. Cl. CPC A23L 2/54; A23L 2/56; A23L 2/60; A23L 2/68

(57) ABSTRACT

The present disclosure relates to a beverage base comprising water; a nutritive sweetener in an amount of 12 Brix or less or a non-nutritive sweetener or a combination of both; and at least one multifunctional component selected from aspartame, acesulfame potassium, sucralose, quillaia extract, class 1 caramel, emulsifying pectin, a flavoring, and any combination thereof. The viscosity of the beverage base at 21.1° C. is about 1.01-1.8 cP. When a 50 mL sample of the beverage base is subjected to a foam analyzer and air is injected into the sample at a flow rate of 400 mL/min, the beverage base holds a foam volume of about 20 mL or more for 8 minutes or longer. The present disclosure is further related to a ready to drink beverage comprising the beverage base and at least one dissolved gas.

### BACKGROUND

Canned liquid beverages are often carbonated such that bubbles and/or foam will form upon dispensing the beverage. When a container, such as a can or bottle, is opened, the pressure is decreased, which causes carbon dioxide that is dissolved in the liquid beverage to be released as bubbles. Bubbles can nucleate in several ways, including from imperfections in the container in which the beverage was poured, residual impurities on the walls of the container, or minor impurities within the beverage. However, CO₂ bubbles from such nucleation sites do not provide a foam that is stable over the course of minutes nor the desired mouthfeel associated with a creamy foam head.

Thus, there is a need for a beverage, such as a reduced or zero sugar soda, with a stable foam head that provides an improved texture and cascade of bubbles.

### BRIEF SUMMARY

The present disclosure relates to a beverage base comprising water; a nutritive sweetener in an amount of 12 Brix or less, a non-nutritive sweetener, or a combination of both; and at least one multifunctional component selected from the group consisting of aspartame, acesulfame potassium, sucralose, quillaia extract, class 1 caramel, emulsifying pectin, a flavoring, and any combination thereof; wherein the viscosity of the beverage base at 21.1° C. (70° F.) is about 1.01 to about 1.8 cP; and wherein the beverage base has a property that when a 50 mL sample of the beverage base is subjected to a foam analyzer and air is injected into the sample at a flow rate of 400 mL/min, the beverage base holds a foam volume of about 20 mL or more for 8 min or longer.

In some embodiments, the multifunctional component comprises quillaia extract, class 1 caramel, or a combination thereof. In some embodiments, the multifunctional component comprises aspartame, acesulfame potassium, or a combination thereof.

In some embodiments, the beverage base comprises a nutritive sweetener that is sucrose or high fructose corn syrup. In some embodiments, the nutritive sweetener is present in an amount of 11 Brix or less.

In some embodiments, a non-nutritive sweetener is present in the beverage base. In some embodiments, the non-nutritive sweetener is natural or synthetic. In some embodiments, the non-nutritive sweetener is a steviol glycoside, monk fruit extract, aspartame, acesulfame potassium, a sugar alcohol, or any combination thereof. In some embodiments, the steviol glycoside is stevioside, dulcoside, rebaudioside A, rebaudioside B, rebaudioside C, rebaudioside D, rebaudioside E, rebaudioside F, rebaudioside M, or any combination thereof. In some embodiments, the steviol glycoside is rebaudioside A, rebaudioside D, rebaudioside M, or any combination thereof. In some embodiments, the non-nutritive sweetener is monk fruit extract, aspartame, acesulfame potassium, rebaudioside A, rebaudioside D, rebaudioside M, or any combination thereof. In some embodiments, the non-nutritive sweetener is monk fruit extract. In some embodiments, the non-nutritive sweetener is a combination of aspartame and acesulfame potassium. In any of these embodiments, the beverage base can further comprise erythritol.

In some embodiments, the non-nutritive sweetener is present in a total amount from about 0.001 to about 3 wt %.

In some embodiments, the beverage base further comprises at least one additive. In some embodiments, the at least one additive is selected from the group consisting of caffeine, an acidulant, a salt, a taste-improving additive, a preservative, an antioxidant, a flavoring, a color, and any combination thereof. In some embodiments, the acidulant is phosphoric acid, citric acid, malic acid, tartaric acid, lactic acid, fumaric acid, ascorbic acid, gluconic acid, succinic acid, maleic acid, adipic acid, cinnamic acid, glutaric acid, carbonic acid, or any combination thereof. In some embodiments, the preservative is a benzoate, a propionate, a sorbate, a citrate, an edetate, a polyphosphate, or any combination thereof. In some embodiments, the antioxidant is a vitamin, a polyphenol, citric acid, oxalic acid, glutamic acid, aspartic acid, phosphoric acid, polyphosphoric acid, a phosphonate, ethylenediaminetetraacetic acid, diethylenetriaminepentaacetic acid, hydroxyethylethylenediaminetriacetic acid, iminodisuccinic acid, any salt thereof, butylated hydroxytoluene (BHT), tert-butylhydroquinone (TBHQ), dehydroacetic acid, dimethyldicarbonate, ethoxyquin, heptylparaben, or any combination thereof. In some embodiments, the flavoring is citrus, cola, vanilla, root beer, fruit, or any combination thereof.

In some embodiments, the beverage base has a property that a foam volume maximum of about 200 to about 230 mL is provided when a 50 mL sample of the beverage base is subjected to a foam analyzer and air is injected into the sample at a flow rate of 400 mL/min.

In some embodiments, the beverage base holds a foam volume of about 30 mL or more for about 8 min or longer.

The present disclosure further relates to a ready to drink beverage comprising a beverage base, as described herein, and at least one dissolved gas. In some embodiments, the at least one dissolved gas comprises carbon dioxide, nitrogen, nitrous oxide, oxygen, compressed air, or a combination thereof. In some embodiments, the at least one dissolved gas comprises a combination of carbon dioxide and nitrogen gas. In some embodiments, the carbon dioxide and nitrogen gas are in a volume ratio of about 90:10 to about 10:90. In some embodiments, the carbon dioxide and nitrogen gas are in a volume ratio of about 50:50.

In some embodiments, the ready to drink beverage is disposed in a sealed container. In some embodiments, the sealed container further comprises a widget.

In some embodiments, the ready to drink beverage has a foam with a mean bubble radius of about 0.005 to about 0.1 mm for at least 100 sec after being unsealed and poured into a drinking glass. In some embodiments, the ready to drink beverage has a foam with a mean bubble radius of about 0.01 to about 0.08 mm for at least 200 sec after being unsealed and poured into a drinking glass.

Additional embodiments and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS/FIGURES

FIG. 1 shows a plot of foam volume (mL) as a function of time (seconds) for beverage base formulations comprising full sugar (Formula 1; solid line) or zero sugar (Formulas 2-4). Formula 2 comprised 600 ppm aspartame (APM) and 90 ppm acesulfame potassium (ASK) (dotted line). Formula 3 comprised 600 ppm APM, 90 ppm ASK, and 1 wt % erythritol (short-dashed line). Formula 4 comprised 600 ppm APM, 90 ppm ASK, and 2 wt % erythritol (long-dashed line).

FIG. 2 shows a plot of mean bubble radius (mm) for Formulas 1 (solid line), 2 (dotted line), and 4 (long-dashed line). The beverage bases were used to form a ready to drink beverage by the addition of carbon dioxide and liquid nitrogen.

FIG. 3 shows a plot of foam volume (mL) as a function of time (seconds) for beverage base formulations comprising full sugar (Formula 1; solid line) or zero sugar and either no quillaia extract (Formula 5; dotted line) or with quillaia extract (Formula 7; dashed line).

FIG. 4 shows a plot of foam volume (mL) as a function of time (seconds) for beverage base formulations comprising full sugar (Formula 1; solid line) or zero sugar (Formulas 2-4). Formula 2 (dotted line) comprised 600 ppm APM, 90 ppm ASK, and quillaia extract. Formula 3 (short-dashed line) comprised 600 ppm APM, 90 ppm ASK, quillaia extract, and 1 wt % erythritol. Formula 4 (long-dashed line) comprised 600 ppm APM, 90 ppm ASK, quillaia extract, and 2 wt % erythritol.

FIG. 5 shows a plot of foam and liquid volume (mL) as a function of time (seconds) for beverage base formulations comprising full sugar (Formula 1; solid line) or zero sugar (Formulas 9-12). Formula 9 (long-dashed line) comprised 600 ppm APM and 90 ppm ASK. Formula 10 (dashed and dotted line) comprised 600 ppm APM, 90 ppm ASK, and 1 wt % erythritol. Formula 11 (short-dashed line) comprised 380 ppm APM and 110 ppm ASK. Formula 12 (dotted line) comprised 580 ppm APM and 40 ppm ASK.

FIG. 6 shows a plot of foam volume (mL) as a function of time (seconds) for ready to drink beverages, including Nitro PEPSI® (⋄) and Nitro PEPSI® Vanilla (●), Formula 13 comprising 350 ppm APM, 90 ppm ASK, and no erythritol (▴), and Formula 14 comprising 350 ppm APM, 90 ppm ASK, and 1 wt % erythritol (▪).

FIG. 7 shows a plot of mean bubble radius (mm) for Nitro PEPSI® (dash lined), Nitro PEPSI® Vanilla (solid line), and Formula 13 comprising 350 ppm APM, 90 ppm ASK, and no erythritol (dotted line).

FIG. 8 shows a plot of foam volume (mL) as a function of time (seconds) for Formula 15 (base control; solid line), Formula 16 (base+400 ppm Reb M 99; dotted line), Formula 17 (base+400 ppm Reb A 97; short-dashed line); Formula 18 (base+400 ppm monk fruit; long-dashed line); and Formula 19 (base+400 ppm Reb D 95; dashed-dotted line).

FIG. 9 shows a plot of mean bubble radius (mm) for Formula 15 (base control; solid line) and Formula 16 (base+400 ppm Reb M 99; dotted line).

FIGS. 10A-10H are a series of micrographs over time of the bubbles formed from Formula 15 (FIGS. 10A-10D) and Formula 16 (FIGS. 10E-10H).

FIG. 11 shows a plot of mean bubble radius (mm) for Formula 15 (base control; solid line) and Formula 17 (base+400 ppm Reb A 97; dotted line).

FIGS. 12A-12H are a series of images over time of the bubbles formed from Formula 15 (FIGS. 12A-12D) and Formula 17 (FIGS. 12E-12H).

FIG. 13 shows a plot of mean bubble radius (mm) for Formula 15 (base control; solid line) and Formula 18 (base+400 ppm Reb D 95; dotted line).

FIGS. 14A-14H are a series of images over time of the bubbles formed from Formula 15 (FIGS. 14A-14D) and Formula 18 (FIGS. 14E-14H).

FIG. 15 shows a plot of mean bubble radius (mm) for Formula 15 (control; solid line) and Formula 19 (base+400 ppm monk fruit; dotted line).

FIGS. 16A-16H are a series of images over time of the bubbles formed from Formula 15 (FIGS. 16A-16D) and Formula 19 (FIGS. 16E-16H).

### DETAILED DESCRIPTION

The headings provided herein are not limitations of the various embodiments of the disclosure, which can be defined by reference to the specification as a whole. It is also to be understood that the terminology used herein is for the purpose of describing particular embodiments only, and is not intended to be limiting, since the scope of the present disclosure will be limited only by the appended claims.

### Definitions

For convenience, the meaning of some terms and phrases used in the specification, examples, and appended claims are provided below. Unless stated otherwise, or implicit from context, the following terms and phrases include the meanings provided below. The definitions are provided to aid in describing particular embodiments, and are not intended to limit the claimed technology, because the scope of the technology is limited only by the claims. Unless otherwise defined, all technical and scientific terms used herein have the same meaning as commonly understood by one of ordinary skill in the art to which this technology belongs. If there is an apparent discrepancy between the usage of a term in the art and its definition provided herein, the definition provided within the specification will control.

The articles “a,” “an,” and “the” are used herein to refer to one or to more than one (i.e., to at least one) of the grammatical object of the article. By way of example, “an element” means one element or more than one element.

As used herein, the term “about” means within an acceptable error range for the particular value as determined by one of ordinary skill in the art, which depends in part on how the value is measured or determined, i.e., the limitations of the measurement system. For example, “about” can mean a range of up to 10% (e.g., up to 5% or up to 1%) of a given value.

The term “at least” prior to a number or series of numbers is understood to include the number associated with the term “at least,” and all subsequent numbers or integers that could logically be included, as clear from context. When at least is present before a series of numbers or a range, it is understood that “at least” can modify each of the numbers in the series or range. For example, “at least 3” means at least 3, at least 4, at least 5, etc. When at least is present before a component in a method step, then that component is included in the step, whereas additional components are optional.

As used herein, the terms “comprises,” “comprising,” “having,” “including,” “containing,” and the like are open-ended terms meaning “including, but not limited to.” To the extent a given embodiment disclosed herein “comprises” certain elements, it should be understood that present disclosure also specifically contemplates and discloses embodiments that “consist essentially of” those elements and that “consist of” those elements.

As used herein the terms “consists essentially of,” “consisting essentially of,” and the like are to be construed as a semi-closed terms, meaning that no other ingredients which materially affect the basic and novel characteristics of an embodiment are included.

As used herein, the terms “consists of,” “consisting of,” and the like are to be construed as closed terms, such that an embodiment “consisting of” a particular set of elements excludes any element, step, or ingredient not specified in the embodiment.

As used herein, the term “beverage base” refers to liquid composition as described herein that does not contain the volume of dissolved gas typically found in a ready to drink carbonated beverage (e.g., less than about 5 volumes of CO₂ or an equivalent amount of a mixture of gasses, less than about 4 volumes of CO₂ or an equivalent amount of a mixture of gasses, less than about 3 volumes of CO₂ or an equivalent amount of a mixture of gasses, less than about 2 volumes of CO₂ or an equivalent amount of a mixture of gasses, less than about 1 volume of CO₂ or an equivalent amount of a mixture of gasses, or less than about 0.5 volumes of CO₂ or an equivalent amount of a mixture of gasses). In some embodiments, a beverage base can comprise water; a nutritive sweetener in an amount of 12 Brix or less, a non-nutritive sweetener, or a combination of both; and at least one multifunctional component selected from the group consisting of aspartame, acesulfame potassium, sucralose, quillaia extract, class 1 caramel, an emulsifying pectin, a flavoring, and any combination thereof, and no added effervescent gas.

As used herein, the term “Brix” or “Degrees Brix” is a unit of measurement typically associated with the amount of dissolved sugar in water. One degree Brix is equal to 1 gram of sucrose in 100 grams of solution (1 wt %).

As used herein, the term “class 1 caramel” is also known as plain caramel, and is formed by cooking a carbohydrate, typically glucose or sucrose, with an acid, base, or salt (e.g., citric acid). Class 1 caramel generally ranges in hue from yellow to red-brown and has a neutral charge or slight negative colloidal charge. In some embodiments, class 1 caramel acts as both a surface active agent and a coloring agent.

As used herein, the term “multifunctional component” refers to a compound that acts as a surface active agent and has at least one other function. The other function can be, for example, flavoring, sweetening, coloring, foaming, thickening, stabilizing, gelling, or any combination thereof. Examples of a multifunctional component include, e.g., aspartame (e.g., sweetening and surface active agent), acesulfame potassium (e.g., sweetening and surface active agent), sucralose (e.g., sweetening and surface active agent), quillaia extract (e.g., foaming and surface active agent), class 1 caramel (e.g., coloring and surface active agent), an emulsifying pectin (e.g., thickening and surface active agent), a flavoring (e.g., flavoring and surface active agent), and any combination thereof.

As used herein, the term “quillaia extract” refers to a concentrated purified extract of the outer cambium layer (bark) of the Quillaia saponaria Molina tree, native to Chile. Quillaia extract is also known as Murillo bark extract, Panama bark extract, Quillaia extract, Quillay bark extract, and Soapbark extract. Quillaia extract (type 1) contains triterpenoid saponins, consisting predominantly of glycosides of quillaic acid. Polyphenols and tannins are also major components. Some simple sugars and calcium oxalate are also present. Quillaia extract (type 2) is produced by subjecting Quillaia extract (type 1) to ultra-filtration or affinity chromatography to remove unwanted solids, such as polyphenols, and has a higher saponin concentration than Quillaia extract (type 1). In some embodiments, the quillaia extract is type 1, type 2, or a combination of type 1 and type 2. In some embodiments, quillaia extract acts as both a surface active agent and a foaming agent. Quillaia extract (either as type 1, type 2, or a combination thereof) can be purchased from various commercial suppliers.

As used herein, the term “surface active agent” refers to a surfactant or other compound that can decrease the surface tension or interfacial tension between two liquids, a liquid and a gas, or a liquid and a solid. In some embodiments, the surface active agent is an amphiphilic compound characterized by a hydrophilic head group and a hydrophobic tail. In other embodiments, the surface active agent is not amphiphilic but still provides the desired decrease in surface tension or interfacial tension between two liquids, a liquid and a gas, or a liquid and a solid.

As used herein, the term “widget” is a term of art as used in the beer industry. A widget is a hollow device, typically with at least one opening, designed to hold one or more dissolved gases that can be included in a sealed container along with a liquid beverage. The widget can serve as a bubble nucleation site upon unsealing the container and dispensing the beverage. A widget can either be fixed to the container base or unattached so it either floats in the liquid beverage or sinks to the container base.

### Compositions and Methods of the Disclosure

Conventional carbonated beverages fizz when dispensed, but any head that is produced is short lived and does not necessarily add to the consumer's tasting experience. The present disclosure is based, at least in part, on the discovery that it is possible to provide an effervescent reduced sugar or sugar free beverage, such as soda or a soft drink, having a smooth taste, the bite expected from a carbonated beverage, a theatrical foam cascade, and a stable foam head. In a fully calorie beverage, dissolved sugar typically provides foam stability by slowing down liquid drainage in foam. It has now, however, been surprisingly discovered that desirable foaming and cascading properties can likewise be provided in a reduced sugar or sugar free ready to drink beverage described herein.

Accordingly, the present disclosure describes a beverage base that comprises, consists essentially of, or consists of: water; a nutritive sweetener in an amount of 12 Brix or less, a non-nutritive sweetener, or a combination of both; and at least one multifunctional component selected from the group consisting of aspartame, acesulfame potassium, sucralose, quillaia extract, class 1 caramel, an emulsifying pectin, a flavoring, and any combination thereof. The beverage base has a viscosity at 21.1° C. (70° F.) of about 1.01 to about 1.8 cP; and the beverage base has a property that when a 50 mL sample of the beverage base is subjected to a foam analyzer and air is injected into the sample at a flow rate of 400 mL/min, the beverage base holds a foam volume of about 20 mL or more for 8 min or longer. The present disclosure also describes, among other things, a ready to drink beverage comprising the beverage base and at least one dissolved gas.

The beverage base comprises water. In some aspects, the beverage base can comprise from about 96 wt % to about 99.5 wt % of water relative to the total weight of the beverage base. For example, the water content can be from about 96.5 wt % to 99.5 wt %, about 97 wt % to about 99.5 wt %, about 97.5 wt % to about 99.5 wt %, about 98 wt % to about 99.5 wt %, about 98.5 wt % to about 99.5 wt %, about 99 wt % to about 99.5 wt %, 96 wt % to about 99.2 wt %, about 96.5 wt % to 99.2 wt %, about 97 wt % to about 99.2 wt %, about 97.5 wt % to about 99.2 wt %, about 98 wt % to about 99.2 wt %, about 98.2 wt % to about 99.2 wt %, about 99 wt % to about 99.2 wt %, about 96 wt %, about 96.5 wt %, about 97 wt %, about 97.2 wt %, about 97.5 wt %, about 98 wt %, about 98.2 wt %, about 98.5 wt %, about 99 wt %, about 99.2 wt %, or about 99.5 wt % of the total weight of the beverage base. In some aspects, the beverage base can comprise from about 97 wt % to about 99.5 wt % of water relative to the total weight of the beverage base. In some aspects, the beverage base can comprise from about 97.2 wt % to about 99.2 wt % of water relative to the total weight of the beverage base.

The beverage base comprises at least one multifunctional component (e.g., 1, 2, 3, 4, or 5, etc. multifunctional component). Examples of multifunctional components include, e.g., aspartame (e.g., sweetening and surface active agent), acesulfame potassium (e.g., sweetening and surface active agent), sucralose (e.g., sweetening and surface active agent), quillaia extract (e.g., foaming and surface active agent), class 1 caramel (e.g., coloring and surface active agent), an emulsifying pectin (e.g., thickening and surface active agent), a flavoring (e.g., flavoring and surface active agent), and any combination thereof.

The emulsifying pectin can be from any suitable plant source, such as citrus (e.g., oranges, grapefruits, lemons, etc.), apples, carrots, beets, and okra. In some embodiments, beverage base can comprise a citrus pectin.

The flavoring (i.e., flavoring agent) can be any food safe compound that can act as a surface active agent and also as a flavoring for the beverage base and ready to drink beverage. The flavoring agent can be natural or synthetic and includes, for example, a citrus flavor (e.g., limonene, octanal), a cola flavor, a vanilla flavor (e.g., vanilla extract, vanillin), a cream flavor, a cinnamon flavor (e.g., cinnamic acid), a rootbeer flavor, a fruit flavor (e.g., a berry flavor, such as cherry, raspberry, or strawberry, and other fruit flavors, such as grape, pineapple, mango, passionfruit), and combinations thereof. In some embodiments, the multifunctional component can be cola flavoring, vanilla flavoring, cream flavoring, berry flavoring, or any combination thereof. In some embodiments, the multifunctional component can be cola flavoring. In some embodiments, the multifunctional component can be vanilla flavoring. In some embodiments, the multifunctional component can be berry flavoring, such as strawberry flavoring. In some embodiments, the multifunctional component can be a combination of cream flavoring and berry flavoring, such as strawberry flavoring.

In some embodiments, the multifunctional component comprises quillaia extract, class 1 caramel, or a combination thereof. In some embodiments, the multifunctional component comprises a combination of quillaia extract and class 1 caramel. In some embodiments, the multifunctional component comprises a combination of quillaia extract, class 1 caramel, and at least one flavoring. In some embodiments, the multifunctional component comprises quillaia extract. In some embodiments, the multifunctional component comprises aspartame, acesulfame potassium, or a combination thereof. In some embodiments, the multifunctional component comprises a combination of aspartame and acesulfame potassium. In some embodiments, the multifunctional component comprises a combination of quillaia extract, aspartame, and acesulfame potassium. In some embodiments, the multifunctional component comprises a combination of quillaia extract, class 1 caramel, aspartame, and acesulfame potassium. In some embodiments, the multifunctional component comprises a combination of quillaia extract, at least one flavoring, aspartame, and acesulfame potassium. In some embodiments, the multifunctional component comprises a combination of quillaia extract, class 1 caramel, at least one flavoring, aspartame, and acesulfame potassium.

In some embodiments, the beverage base can comprise a total amount of at least one multifunctional component (e.g., quillaia extract, class 1 caramel, a flavoring, aspartame, acesulfame potassium, or any combination thereof) from about 0.001 wt % to about 3 wt % relative to the total weight of the beverage base. For example, the total multifunctional component content can be from about 0.001 wt % to about 2.5 wt %, about 0.001 wt % to about 2 wt %, about 0.001 wt % to about 1.5 wt %, about 0.001 wt % to about 1 wt %, about 0.005 wt % to about 3 wt %, about 0.005 wt % to about 2.5 wt %, about 0.005 wt % to about 2 wt %, about 0.005 wt % to about 1.5 wt %, about 0.005 wt % to about 1 wt %, about 0.01 wt % to about 3 wt %, about 0.01 wt % to about 2.5 wt %, about 0.01 wt % to about 2 wt %, about 0.01 wt % to about 1.5 wt %, about 0.01 wt % to about 1 wt %, about 0.05 wt % to about 3 wt %, about 0.05 wt % to about 2.5 wt %, about 0.05 wt % to about 2 wt %, about 0.05 wt % to about 1.5 wt %, about 0.05 wt % to about 1 wt %, about 0.1 wt % to about 3 wt %, about 0.1 wt % to about 2.5 wt %, about 0.1 wt % to about 2 wt %, about 0.1 wt % to about 1.5 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, or about 3 wt % of the total weight of the beverage base. In some embodiments, the total amount of the multifunctional component is from about 0.001 to about 2 wt % in the beverage base. In some embodiments, the total amount of the multifunctional component is from about 0.01 to about 1 wt % in the beverage base. In some embodiments, the total amount of the multifunctional component is from about 0.1 to about 1 wt % in the beverage base.

The beverage base has a viscosity at 21.1° C. (70° F.) of about 1.01 to about 1.8 cP (centipoise). In some embodiments, the beverage base has a viscosity at 21.1° C. (70° F.) of about 1.01 to about 1.7 cP (e.g., about 1.02 to about 1.65 cP, about 1.04 to about 1.62 cP). In some embodiments, the beverage base has a viscosity at 4.4° C. (40° F.) of about 1.4 to about 2.8 cP (e.g., about 1.5 to about 2.7 cP, about 1.6 to about 2.6 cP). The viscosity can be measured using any suitable instrument, such as an MCR 702 Rheometer (Anton Paar, Austria).

The beverage base comprises a nutritive sweetener in an amount of 12 Brix or less, a non-nutritive sweetener, or a combination of both a nutritive sweetener in an amount of 12 Brix or less and a non-nutritive sweetener.

In some embodiments, the beverage base can comprise at least one nutritive sweetener (e.g., 1, 2, 3, etc. nutritive sweeteners). Typical nutritive sweeteners include, e.g., sugar (i.e., sucrose), high fructose corn syrup, fruit juice, and combinations thereof. High fructose corn syrup (also known as glucose-fructose and isoglucose) can be, for example, “HFCS 42” and/or “HFCS 55,” which refers to the dry weight of fructose being 42% and 55% respectively, and the remainder glucose.

In some embodiments, the nutritive sweetener can be sucrose. In some embodiments, the nutritive sweetener can be high fructose corn syrup (e.g., HFCS 42, HFCS 55, or a combination thereof).

As the beverage base and corresponding ready to drink beverage are considered to be reduced sugar or zero sugar, when a nutritive sweetener is used, the nutritive sweetener is used in an amount of 12 Brix or less. For example, the nutritive sweetener (e.g., HFCS) can be present in the beverage base in an amount that is about 11.5 Brix or less (e.g., about 11 Brix or less, about 10.5 Brix or less, about 10 Brix or less, about 9.5 Brix or less, about 9 Brix or less, about 8.5 Brix or less, about 8 Brix or less, about 7.5 Brix or less, about 7 Brix or less, about 6.5 Brix or less, about 6 Brix or less, about 5.5 Brix or less, about 5 Brix or less, about 4.5 Brix or less, about 4 Brix or less, about 3.5 Brix or less, about 3 Brix or less, about 2.5 Brix or less, about 2 Brix or less, about 1.5 Brix or less, about 1 Brix or less, or about 0.5 Brix or less). In some embodiments, the nutritive sweetener can be present in the beverage base in an amount of 11 Brix or less.

In some embodiments, the beverage base can comprise at least one non-nutritive sweetener (e.g., 1, 2, 3, etc. non-nutritive sweeteners). The non-nutritive sweetener can be natural or synthetic or a mixture of a natural non-nutritive sweetener and a synthetic non-nutritive sweetener.

Examples of a natural non-nutritive sweetener include, e.g., a steviol glycoside (e.g., an extract of Stevia rebaudiana), a sugar alcohol (e.g., erythritol, sorbitol, mannitol, xylitol, lactitol, isomalt, maltitol), allulose, yacon syrup, thaumatin (e.g., talin), monk fruit extract, and any combination thereof. In some embodiments, the non-nutritive sweetener can be a steviol glycoside, monk fruit extract, aspartame, acesulfame potassium, a sugar alcohol, or any combination thereof.

Suitable steviol glycosides include, but are not limited to, rebaudioside A (Reb A), rebaudioside B (Reb B), rebaudioside C (Reb C), rebaudioside D (Reb D), rebaudioside E (Reb E), rebaudioside F (Reb F), rebaudioside G (Reb G), rebaudioside I (Reb I), rebaudioside J (Reb J), rebaudioside KA (Reb KA), rebaudioside M (Reb M), rebaudioside V (Reb V), rebaudioside W (Reb W), steviolbioside, stevioside, rubusoside, and dulcoside A. The steviol glycoside can be used singly or as a mixture of two or more. In certain embodiments, the steviol glycoside can be a complex between rebaudioside D and Stevioside such as disclosed and described in U.S. Patent Application Publication No. 2023/0301334, the entirety of which is incorporated herein by reference.

In some embodiments, the non-nutritive sweetener can be a steviol glycoside. In some embodiments, the steviol glycoside can be stevioside, dulcoside, rebaudioside A, rebaudioside B, rebaudioside C, rebaudioside D, rebaudioside E, rebaudioside F, rebaudioside M, or any combination thereof. In some embodiments, the steviol glycoside can be rebaudioside A (e.g., Reb A 97, which is rebaudioside A with 97% purity), rebaudioside D (e.g., Reb D 95, which is rebaudioside D with 95% purity), rebaudioside M (e.g., Reb M 99, which is rebaudioside M with 99% purity), or any combination thereof. In some embodiments, the steviol glycoside can be rebaudioside A. In some embodiments, the steviol glycoside can be rebaudioside D. In some embodiments, the steviol glycoside can be rebaudioside M. In some embodiments, the beverage base can comprise a combination of rebaudioside A and rebaudioside D. In some embodiments, the beverage base can comprise a combination of rebaudioside A and rebaudioside M. In some embodiments, the beverage base can comprise a combination of rebaudioside D and rebaudioside M. In some embodiments, the beverage base can comprise a combination of rebaudioside A, rebaudioside D, and rebaudioside M. In any of these embodiments, the beverage base can further comprise erythritol (e.g., a combination of erythritol and at least one steviol glycoside, such as a combination of erythritol and Reb A, erythritol and Reb D, erythritol and Reb M, erythritol in combination with Reb A and Reb D, erythritol in combination with Reb A and Reb M, erythritol in combination with Reb D and Reb M, or erythritol in combination with Reb A, Reb D, and Reb M).

Examples of a synthetic non-nutritive sweetener include, e.g., saccharin, aspartame, acesulfame potassium (ace-K or ASK), sucralose, neotame, advantame, and any combination thereof.

In some embodiments, the beverage base can comprise monk fruit extract. In some embodiments, the beverage base can comprise aspartame. In some embodiments, the beverage base can comprise acesulfame potassium. In some embodiments, the beverage base can comprise a combination of aspartame and acesulfame potassium. In any of these embodiments, the beverage base can further comprise erythritol (e.g., a combination of erythritol and monk fruit, a combination of erythritol and aspartame, a combination of erythritol and acesulfame potassium, or a combination of erythritol, aspartame, and acesulfame potassium). In some embodiments, the beverage base can comprise erythritol as the non-nutritive sweetener.

In some embodiments, the beverage base can comprise a total amount of at least one non-nutritive sweetener (e.g., aspartame, ace-K, erythritol, a steviol glycoside, or any combination) from about 0.001 wt % to about 3 wt % relative to the total weight of the beverage base. For example, the total non-nutritive sweetener content can be from about 0.001 wt % to about 2.5 wt %, about 0.001 wt % to about 2 wt %, about 0.001 wt %, to about 1.5 wt %, about 0.001 wt % to about 1 wt %, about 0.005 wt % to about 3 wt %, about 0.005 wt % to about 2.5 wt %, about 0.005 wt % to about 2 wt %, about 0.005 wt % to about 1.5 wt %, about 0.005 wt % to about 1 wt %, about 0.01 wt % to about 3 wt %, about 0.01 wt % to about 2.5 wt %, about 0.01 wt % to about 2 wt %, about 0.01 wt % to about 1.5 wt %, about 0.01 wt % to about 1 wt %, about 0.05 wt % to about 3 wt %, about 0.05 wt % to about 2.5 wt %, about 0.05 wt % to about 2 wt %, about 0.05 wt % to about 1.5 wt %, about 0.05 wt % to about 1 wt %, about 0.1 wt % to about 3 wt %, about 0.1 wt % to about 2.5 wt %, about 0.1 wt % to about 2 wt %, about 0.1 wt % to about 1.5 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, or about 3 wt % of the total weight of the beverage base. In some embodiments, the total amount of non-nutritive sweetener can be from about 0.001 wt % to about 2 wt % in the beverage base. In some embodiments, the total amount of non-nutritive sweetener can be from about 0.01 wt % to about 1 wt % in the beverage base. In some embodiments, the total amount of non-nutritive sweetener can be from about 0.1 wt % to about 1 wt % in the beverage base.

In some embodiments, the beverage base or a ready to drink beverage prepared from the beverage base can further comprise at least one additive (e.g., 1, 2, 3, 4, 5, 6, 7, or 8 additives). In some embodiments, the additive can be selected from the group consisting of caffeine, an acidulant, a salt, a taste-improving additive, a preservative, an antioxidant, a flavoring, a color, and any combination thereof. In some embodiments, additives that do not have a material effect can be included in the beverage base.

In some embodiments, the beverage base can comprise caffeine, such as anhydrous caffeine.

In some embodiments, the beverage base can comprise at least one acidulant (e.g., 1, 2, 3, etc. acidulants). The acidulant can be any food safe acid used in beverages. In some embodiments, the acidulant can be phosphoric acid, citric acid, malic acid, tartaric acid, lactic acid, fumaric acid, ascorbic acid, gluconic acid, succinic acid, maleic acid, adipic acid, cinnamic acid, glutaric acid, carbonic acid, or any combination thereof. In some embodiments, the acidulant can be phosphoric acid. In some embodiments, the acidulant can be citric acid. In some embodiments, the acidulant can be tartaric acid. In some embodiments, the acidulant can be a combination of phosphoric acid and citric acid. In some embodiments, the acidulant can be a combination of phosphoric acid and tartaric acid. In some embodiments, the acidulant can be a combination of phosphoric acid, citric acid, and tartaric acid.

In some embodiments, the beverage base can comprise at least one salt (e.g., 1, 2, 3, etc. salts). In general, the salt can be any food safe salt, including inorganic salts. In some embodiments, the salt can be a chloride, a sulfate, or any combination thereof. The salts can have any suitable counterion, such as a Group I or Group II cation. Specific examples of salt include, e.g., sodium chloride, potassium chloride, potassium sulfate, calcium chloride, magnesium sulfate, magnesium chloride, and any combination thereof. In some embodiments, the salt can be sodium chloride.

In some embodiments, the beverage base can comprise at least one taste-improving additive (e.g., 1, 2, 3, etc. taste-improving additives). In some embodiments, a taste-improving additive can be a salt of an organic acid. For example, a suitable taste-improving additive can be a sodium, calcium, potassium, or magnesium salt of an organic acid, e.g., salts of citric acid, malic acid, tartaric acid, fumaric acid, lactic acid (e.g., sodium lactate, potassium lactate), alginic acid (e.g., sodium alginate), ascorbic acid (e.g., sodium ascorbate, calcium ascorbate), benzoic acid (e.g., sodium benzoate or potassium benzoate), glutamic acid (e.g., monosodium glutamate), adipic acid, and any combination thereof.

In some embodiments, the beverage base can comprise at least one preservative (e.g., 1, 2, 3, etc. preservatives). In some embodiments, the preservative can be a benzoate, a propionate, a sorbate, a citrate, an edetate, a polyphosphate, or any combination thereof. The counterion for such preservatives can be any suitable counterion, such as a Group I or Group II cation. In some embodiments, the preservative can be sodium benzoate, calcium propionate, potassium sorbate, sodium sorbate, calcium disodium edetate, a sodium polyphosphate (e.g., sodium acid polyphosphate, sodium hexametaphosphate, sodium tripolyphosphate, tetrasodium pyrophosphate, or sodium trimetaphosphate), or any combination thereof. In some embodiments, the beverage base can comprise sodium benzoate, potassium sorbate, calcium disodium edetate, sodium hexametaphosphate, or any combination thereof. In some embodiments, the beverage base can comprise a combination of sodium benzoate, potassium sorbate, calcium disodium edetate, and sodium hexametaphosphate.

In some embodiments, the beverage base can comprise at least one antioxidant (e.g., 1, 2, 3, etc. antioxidants). In some embodiments, the antioxidant can be a vitamin (e.g., ascorbic acid, tocopherol), a polyphenol (e.g., a flavonoid, phenolic acid, lignin, or a stilbene), citric acid, oxalic acid, glutamic acid, aspartic acid, phosphoric acid, polyphosphoric acid (e.g., a polyphosphate), a phosphonate, ethylenediaminetetraacetic acid, diethylenetriaminepentaacetic acid (pentetic acid), hydroxyethylethylenediaminetriacetic acid, iminodisuccinic acid, any salt thereof (e.g., sodium citrate, calcium disodium edetate, disodium edetate, tetrasodium glutamate diacetate, tetrasodium aspartate diacetate, tetrasodium iminodisuccinate), butylated hydroxytoluene (BHT), tert-butylhydroquinone (TBHQ), dehydroacetic acid, dimethyldicarbonate, ethoxyquin, heptylparaben, or any combination thereof. In some embodiments, the beverage base can comprise an edetate, such as calcium disodium edetate.

Vitamin E is a group of eight fat soluble compounds that include four tocopherols (i.e., α-tocopherol, β-tocopherol, γ-tocopherol, and δ-tocopherol) and four tocotrienols (i.e., α-tocotrienol, β-tocotrienol, γ-tocotrienol, and δ-tocotrienol). In some embodiments, the vitamin E can comprise a tocopherol.

In some embodiments, the beverage base can comprise at least one flavoring (e.g., 1, 2, 3, etc. flavorings). The flavoring (e.g., flavoring agent) can be natural or synthetic and can include, for example, a citrus flavor (e.g., limonene, octanal), a cola flavor, a vanilla flavor (e.g., vanilla extract, vanillin), a cream flavor, a cinnamon flavor (e.g., cinnamic acid), a rootbeer flavor, a fruit flavor (e.g., a berry flavor, such as cherry, raspberry, or strawberry, and other fruit flavors, such as grape, pineapple, mango, passionfruit), and any combination thereof. In some embodiments, the flavoring can be cola flavoring, vanilla flavoring, cream flavoring, berry flavoring, or any combination thereof. In some embodiments, the flavoring can be cola flavoring. In some embodiments, the flavoring can be vanilla flavoring. In some embodiments, the flavoring can be berry flavoring, such as strawberry flavoring. In some embodiments, the flavoring can be a combination of cream flavoring and berry flavoring, such as strawberry flavoring.

In some embodiments, the beverage base can comprise at least one color (e.g., 1, 2, 3, etc. color). The color (e.g., coloring agent) can be natural or synthetic and must be food safe. Examples of food safe colorants include, e.g., caramel (e.g., class 1 caramel), FD&C Red 40, FD&C Red No. 3, FD&C Blue No. 1, FD&C Yellow No. 5, FD&C Yellow No. 6, and any combination thereof.

In some embodiments, the beverage base can comprise an additive selected from the group consisting of caffeine, an acidulant, a salt, a preservative, an antioxidant, a flavoring, a color, and any combination thereof. In some embodiments, the beverage base can comprise a combination of caffeine, an acidulant, a salt, a preservative, an antioxidant, a flavoring, and a color.

In some embodiments, the beverage base can comprise from about 0.001 wt % to about 2 wt % of each additive (e.g., a preservative, an acidulant, caffeine, etc.) relative to the total weight of the beverage base. For example, each additive can be present in the beverage base from about 0.001 wt % to about 1.5 wt %, about 0.001 wt % to about 1 wt %, about 0.005 wt % to about 2 wt %, about 0.005 wt % to about 1.5 wt %, about 0.005 wt % to about 1 wt %, about 0.01 wt % to about 2 wt %, about 0.01 wt % to about 1.5 wt %, about 0.01 wt % to about 1 wt %, about 0.05 wt % to about 2 wt %, about 0.05 wt % to about 1.5 wt %, about 0.05 wt % to about 1 wt %, about 0.1 wt % to about 2 wt %, about 0.1 wt % to about 1.5 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, or about 2 wt % of the total weight of the beverage base.

In some embodiments, the total preservative content can be from about 0.05 wt % to about 2 wt % in the beverage base. In some embodiments, the total antioxidant content can be from about 0.001 to about 1 wt % in the beverage base. In some embodiments, the caffeine content can be from about 0.001 to about 1 wt % in the beverage base. In some embodiments, the total salt content can be from about 0.001 to about 0.01 wt % in the beverage base. In some embodiments, the total acidulant content can be from about 0.05 wt % to about 1 wt % in the beverage base. In some embodiments, the total color content can be from about 0.05 wt % to about 0.5 wt % in the beverage base. In some embodiments, the total flavoring content can be from about 0.05 wt % to about 0.5 wt % in the beverage base.

In some embodiments, the beverage base can comprise, consist essentially of, or consist of
water;
a non-nutritive sweetener selected from monk fruit extract, aspartame, acesulfame potassium, rebaudioside A, rebaudioside D, rebaudioside M, erythritol, or any combination thereof;
at least one multifunctional component selected from the group consisting of aspartame, acesulfame potassium, sucralose, quillaia extract, class 1 caramel, emulsifying pectin, a flavoring, and any combination thereof, and
optionally at least one additive selected from the group consisting of caffeine, an acidulant, a salt, a taste-improving additive, a preservative, an antioxidant, a flavoring, a color, and any combination thereof,
wherein the viscosity of the beverage base at 21.1° C. (70° F.) is about 1.01 to about 1.8 cP; and wherein the beverage base has a property that when a 50 mL sample of the beverage base is subjected to a foam analyzer and air is injected into the sample at a flow rate of 400 mL/min, the beverage base holds a foam volume of about 20 mL or more for 8 min or longer.

In some embodiments, the beverage base can comprise, consist essentially of, or consist of
about 96 wt % to about 99.5 wt % water;
about 0.001 wt % to about 3 wt % of a non-nutritive sweetener selected from monk fruit extract, aspartame, acesulfame potassium, rebaudioside A, rebaudioside D, rebaudioside M, erythritol, or any combination thereof,
about 0.001 wt % to about 3 wt % of at least one multifunctional component selected from the group consisting of aspartame, acesulfame potassium, sucralose, quillaia extract, class 1 caramel, emulsifying pectin, a flavoring, and any combination thereof; and
at least one additive selected from the group consisting of caffeine, an acidulant, a salt, a preservative, an antioxidant, a flavoring, a color, and any combination thereof (e.g., a combination of caffeine, an acidulant, a salt, a preservative, an antioxidant, a flavoring, and a color);
wherein the viscosity of the beverage base at 21.1° C. (70° F.) is about 1.01 to about 1.8 cP; and wherein the beverage base has a property that when a 50 mL sample of the beverage base is subjected to a foam analyzer and air is injected into the sample at a flow rate of 400 mL/min, the beverage base holds a foam volume of about 20 mL or more for 8 min or longer.

It was discovered that when the beverage base described herein is combined with at least one gas (e.g., an effervescent gas), an increased volume of foam is produced. The foam produced is stable longer than a comparable reduced sugar or sugar free beverage base that does not comprise a multifunctional component, as described herein, when measured using a foam analyzer. Thus, a ready to drink beverage prepared from a beverage base described herein and at least one gas provides a unique foam profile including a stable foam head that provides an improved texture (e.g., silky texture and/or smooth mouthfeel) and a cascade of bubbles. Foam data can be measured and recorded using a foam analyzer, such as a Foam Scan analyzer (Teclis Scientific, France). A foam analyzer is composed of a light box with a glass column and two cameras that are connected to a computer. The computer contains software (e.g., Foam Scan and CSA (cell size analysis)), which detects and analyzes images from the camera. The cameras are pointed at the glass column, and on the opposite side of the column from the camera is a light source that helps to create contrast in the images. The bubbling of gas in the liquid sample usually generates homogeneous foam, which is uniformly dark. This darkness can be quantified by a gray level, which produces a contrast with respect to the light background of the image of the tube without the foam. The analyses of the gray levels allow the software to calculate the height of the foam and then its volume. When the foam rises in the glass tube during the sparging phase, it is assumed that it is homogeneous at the bottom of the tube. Its opacity is considered by the software to be the reference point. The operator can define what is the bottom of the glass tube by setting a region of interest (an area where the software can look to analyze foam volume).

For example, 50 milliliters of a beverage base is injected (e.g., sparged) into the base of the glass column with a 50 mL syringe. Air is forced through the bottom of the glass column at a flow rate of 400 mL/min. A foam volume maximum is set at 200 mL so that the foam does not overflow over the top of the column, but it is still enough to generate meaningful data. After this 200 mL point is reached, air is no longer forced through the base of the column, but the foam height is still measured until a set stop point. The foam height is recorded so that the foam generation rate can be measured (i.e., how long it takes to reach 200 mL) and the foam collapse rate (i.e., the foam height from the peak point to the end of the experiment).

In some embodiments, the beverage base has a property that a foam volume maximum of about 200 to about 230 mL is provided when a 50 mL sample of the beverage base is subjected to a foam analyzer and air is injected into the sample at a flow rate of 400 mL/min. Other gasses will provide similar foam volume results.

In any of the foregoing embodiments, the beverage base has a property that when a 50 mL sample of the beverage base is subjected to a foam analyzer and air is injected into the sample at a flow rate of 400 mL/min to reach a foam volume maximum of 200 mL, the beverage base has a foam volume of about 80 mL or more for 600 sec or longer. In some embodiments, the beverage base has a foam volume of about 100 mL or more for 500 sec or longer. In some embodiments, the beverage base has a foam volume of about 120 mL or more for 400 sec or longer. In some embodiments, the beverage base has a foam volume of about 140 mL or more for 300 sec or longer. In some embodiments, the beverage base has a foam volume of about 160 mL or more for 100 sec or longer. In some embodiments, the beverage base has a foam volume of about 180 mL or more for 200 sec or longer. In some embodiments, the beverage base has a foam profile (e.g., foam volume) in accordance with one of the figures. Other gasses will provide similar foam volume results.

The beverage base has a property that when a 50 mL sample of the beverage base is subjected to a foam analyzer and air is injected into the sample at a flow rate of 400 mL/min, the beverage base holds a foam volume of about 20 mL or more for 8 min or longer (e.g., about 9 min or more, about 10 min or more, about 12 min or more, about 15 min or more). In some embodiments, the beverage base can hold a foam volume of about 25 mL or more for about 8 min or longer (e.g., about 9 min or more, about 10 min or more, about 12 min or more, about 15 min or more). In some embodiments, the beverage base can hold a foam volume of about 30 mL or more for about 8 min or longer (e.g., about 9 min or more, about 10 min or more, about 12 min or more, about 15 min or more). Other gasses will provide similar foam volume results.

The present disclosure further relates to a ready to drink beverage that can comprise, consist essentially of, or consist of a beverage base according to any of the embodiments described herein and at least one dissolved gas.

In some embodiments, the at least one dissolved gas can comprise an effervescent gas, such as, e.g., carbon dioxide, nitrogen, nitrous oxide, oxygen, compressed air (e.g., comprising at least 78% nitrogen, at least 20% oxygen, and less than 2% argon by volume), or a combination thereof. In some embodiments, the at least one dissolved gas can comprise a combination of carbon dioxide and a second gas, such as nitrogen gas or nitrous oxide. In some embodiments, the at least one dissolved gas can comprise a combination of carbon dioxide and nitrogen gas. In some embodiments, the nitrogen gas is added (e.g., injected, sparged) into the beverage base as liquid nitrogen.

When more than one gas is used, the gasses can be provided in any suitable volume ratio. In some embodiments, two gases (e.g., carbon dioxide and nitrogen gas) can be present in a volume ratio of about 90:10 to about 10:90. In some embodiments, the two gases can be present in a volume ratio (e.g., a carbon dioxide to nitrogen gas volume ratio) of about 85:15 to about 15:85, about 80:20 to about 20:80, about 75:25 to about 25:75, about 70:30 to about 30:70, about 65:35 to about 35:65, or about 60:40 to about 40:60 (e.g., about 50:50). In some embodiments, the two gases can be present in a volume ratio (e.g., a carbon dioxide to nitrogen gas volume ratio) of about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, or about 10:90.

In some embodiments, the at least one dissolved gas comprises a combination of carbon dioxide and nitrogen gas. In some embodiments, the carbon dioxide and nitrogen gas are in a volume ratio of about 90:10 to about 10:90. In some embodiments, the carbon dioxide and nitrogen gas are in a volume ratio of about 50:50.

In some embodiments, the ready to drink beverage can be disposed in a sealed container. The container can be any suitable receptacle that can be sealed after filling, such as a can (e.g., a metal can, such as an aluminum can), carton, bottle (e.g., a glass bottle, a polyester or polyethylene terephthalate (PET) bottle), or keg. In some embodiments, the ready to drink beverage can be disposed in a sealed can (e.g., an aluminum can). In some embodiments, the ready to drink beverage can be disposed in a sealed carton. In some embodiments, the ready to drink beverage can be disposed in a sealed bottle (e.g., a glass bottle). In some embodiments, the ready to drink beverage can be disposed in a sealed keg.

The ready to drink beverage can be prepared using any suitable method. For example, the beverage base can fill the unsealed container to a fill level of at least about 85% (e.g., about 86% or more, about 87% or more, about 88% or more, about 89% or more, about 90% or more, or about 91%) of the total volume of the container, so the container has a head space of at least about 9% (e.g., about 9% to about 15%) of the total volume of the container. The head space can be pressurized with at least one gas to between about 21 psi and about 60 psi, such that upon opening the sealed container and pouring of the ready to drink beverage into a glass a foam (e.g., a foam head) is provided on and/or within the beverage.

In some embodiments, the sealed container can further comprise a widget, such as those used in the beer industry. Without wishing to be bound by theory, it is believed that a widget can provide a nucleation site for bubbles to form. When used, the widget is a device that can be any suitable size or shape (e.g., cylinder, sphere, disk) and made out of any suitable material (e.g., food grade plastic), the only limitation being that the widget should be large enough to prevent it from passing through the container opening when unsealed. Typically, the widget is a hollow body with at least one opening (e.g., a small hole) so that the widget can hold the at least one gas. A widget can be provided that frictionally engages the sidewalls or base of the container, but it is also contemplated that the widget can be free floating within the container. Depending upon the density of the widget, it could therefore either float near the surface of the beverage or sink to the container base. The use of a widget in a gas-containing beverage is described in detail in U.S. Pat. No. 4,832,968, the entire disclosure of which has been incorporated herein by reference.

In some embodiments, the sealed container does not contain a widget.

In some embodiments, the ready to drink beverage provides a foam with a mean (average) bubble radius of about 0.005 to about 0.1 mm for at least 100 sec after being unsealed and poured into a drinking glass (e.g., a pint glass that holds 16 oz (about 473 mL) of liquid). In some embodiments, the mean bubble radius is 0.005 mm or more (e.g., about 0.006 mm or more, about 0.007 mm or more, about 0.008 mm or more, about 0.009 mm or more, about 0.01 mm or more, about 0.02 mm or more, about 0.03 mm or more, about 0.04 mm or more, about 0.05 mm or more, about 0.06 mm or more, about 0.07 mm or more, about 0.08 mm or more, or about 0.09 mm or more,) to about 0.1 mm or less (e.g., about 0.095 mm or less, about 0.09 mm or less, about 0.085 mm or less, about 0.08 mm or less, about 0.075 mm or less, about 0.07 mm or less, about 0.065 mm or less, about 0.06 mm or less, about 0.055 mm or less, about 0.05 mm or less, about 0.045 mm or less, about 0.04 mm or less, about 0.035 mm or less, about 0.03 mm or less, about 0.025 mm or less, about 0.02 mm or less, or about 0.01 mm or less) for at least 100 sec after being unsealed and poured. In some embodiments, the beverage has a mean bubble radius of about 0.005 to about 0.1 mm for at least 200 sec (e.g., about 200 sec or more, about 300 sec or more, about 400 sec or more, about 500 sec or more, about 600 sec or more, about 700 sec or more, or about 800 sec or more), after being unsealed and poured into a drinking glass (e.g., a pint glass that holds 16 oz (about 473 mL) of liquid). In some embodiments, the beverage has a mean bubble radius of about 0.02 to about 0.1 mm for at least 200 sec (e.g., about 200 sec or more, about 300 sec or more, about 400 sec or more, about 500 sec or more, about 600 sec or more, about 700 sec or more, or about 800 sec or more), after being unsealed and poured into a drinking glass (e.g., a pint glass that holds 16 oz (about 473 mL) of liquid). In some embodiments, the ready to drink beverage has a mean bubble radius of about 0.02 to about 0.04 mm for at least 200 sec (e.g., about 200 sec or more, about 300 sec or more, about 400 sec or more, about 500 sec or more, about 600 sec or more, about 700 sec or more, or about 800 sec or more) after being unsealed and poured into a drinking glass (e.g., a pint glass that holds 16 oz (about 473 mL) of liquid). In some embodiments, the ready to drink beverage has a foam with a mean bubble radius of about 0.01 to about 0.08 mm for at least 200 sec after being unsealed and poured into a drinking glass (e.g., a pint glass that holds 16 oz (about 473 mL) of liquid).

In some embodiments, the mean bubble size is monodisperse such that the mean radius does not deviate ±50% (e.g., ±40%, ±30%, ±20%, ±15%, ±10%, ±8%, ±5%, ±3%, ±2%, or ±1%) for about 60 sec or more (e.g., about 100 sec or more, about 200 sec or more, about 300 sec or more, about 400 sec or more, about 500 sec or more, about 600 sec or more, about 700 sec or more, or about 800 sec or more).

The mean bubble radius can be measured using any suitable technique, including using a foam analyzer, such as a Foam Scan analyzer (Teclis Scientific, France).

In some embodiments, the ready to drink beverage has a bubble count of about 200 bubbles or more (e.g., about 300 bubbles or more, about 400 bubbles or more, about 500 bubbles or more, about 600 bubbles or more, about 700 bubbles or more, or about 800 bubbles or more), for at least 100 sec (e.g., about 100 sec or more, about 200 sec or more, about 300 sec or more, about 400 sec or more, or about 500 sec or more) after being unsealed and poured into a drinking glass (e.g., a pint glass holding 16 oz (about 473 mL)). In some embodiments, the ready to drink beverage has a bubble count of about 400 bubbles or more (e.g., about 500 bubbles or more, about 600 bubbles or more, about 700 bubbles or more, or about 800 bubbles or more) for at least 100 sec (e.g., about 100 sec or more, about 200 sec or more, about 300 sec or more, about 400 sec or more, or about 500 sec or more) after being unsealed and poured into a drinking glass (e.g., a pint glass that holds 16 oz (about 473 mL) of liquid). In some embodiments, the ready to drink beverage has a bubble count of about 600 bubbles or more (e.g., about 700 bubbles or more, or about 800 bubbles or more) for at least 100 sec (e.g., about 100 sec or more, about 200 sec or more, about 300 sec or more, about 400 sec or more, or about 500 sec or more) after being unsealed and poured into a drinking glass (e.g., a pint glass that holds 16 oz (about 473 mL) of liquid). In any of these embodiments, the ready to drink beverage has a bubble count of about 1,000 bubbles or less (e.g., about 950 bubbles or less, about 900 bubbles or less, about 800 bubbles or less) for at least 100 sec (e.g., about 100 sec or more, about 200 sec or more, about 300 sec or more, about 400 sec or more, or about 500 sec or more) after being unsealed and poured into a drinking glass (e.g., a pint glass that holds 16 oz (about 473 mL) of liquid). In some embodiments, the ready to drink beverage has a bubble count of about 600 to about 800 bubbles for at least 100 sec (e.g., about 100 sec or more, about 200 sec or more, about 300 sec or more, about 400 sec or more, or about 500 sec or more) after being unsealed and poured into a drinking glass (e.g., a pint glass that holds 16 oz (about 473 mL) of liquid).

The bubble count can be measured using any suitable technique, including using a dynamic foam analyzer. For example, a picture of the bubbles can be taken at a fixed distance between the camera and the foam using a black and white contrast image, and the number of bubbles can be counted within the frame of that image. In some embodiments, the bubble count is measured as the number of bubbles per mm². Methods of counting bubbles in a gas-containing beverage are described in detail in U.S. Pat. No. 5,414,778, the entire disclosure of which is incorporated herein by reference.

### EXAMPLES

The example presented below is provided for the purpose of illustration only and the embodiments described herein should in no way be construed as being limited to this example. Rather, the embodiments should be construed to encompass any and all variations which become evident as a result of the teaching provided herein.

Three different test methods were used to analyze the foam and bubbles of the beverages. Each of these test methods is performed using the same instrument, called the “Foam Scan” (Teclis-Scientific, France), but the instrument parts and parameters are changed to analyze different conditions. The instrument uses image analysis to determine the foam and bubble properties.

“Test A” uses a beverage base made with water but no compressed gasses. The beverage base is injected into a glass column and compressed air is forced through the bottom of the beverage base at a set rate (mL/min) in order to create foam. The test ends when a specified foam height (mL) or time (seconds) is reached.

“Test B” analyzes the foam and bubbles from a nitrogenated/carbonated widget can containing a ready to drink beverage that is poured into a glass cuvette. This test mimics a consumer's experience of pouring the widget can of Nitro PEPSI® into a glass.

“Test C” is similar to the test A but uses the beverage from test B. The beverage is degassed in a sonicator (the beverage can still contain dissolved CO₂ gas after degassing) and then injected into the same glass column from test A. When analyzing the results of test C, it is important to note that de-gassing the beverage will also lose flavor/volatile compounds in the process, but this can help to understand what the foaming and bubble properties look like without the contribution of flavor.

### Example 1

The impact of aspartame (APM), acesulfame potassium (ASK), and erythritol on foam production were evaluated.

Beverage base formulations were prepared in accordance with the ingredients set forth in Table 1. A full sugar, comparative formulation (Formula 1) was prepared with high fructose corn syrup (HFCS). Three zero sugar, inventive formulations were prepared with APM and ASK (Formula 2), APM, ASK, and erythritol in 2 different concentrations (Formulas 3 and 4).

TABLE 1

| | Formula 1 | Formula 2 | Formula 3 | Formula 4 |
|---|---|---|---|---|
| Ingredient | (comparative) | (inventive) | (inventive) | (inventive) |
| Water | 79.87% | 99.22% | 98.22% | 97.22% |
| HFCS 55 @77.00 Brix | 12.67% | 0% | 0% | 0% |
| HFCS 42 @71.00 Brix | 6.77% | 0% | 0% | 0% |
| Potassium Sorbate | 0.01% | 0.01% | 0.01% | 0.01% |
| Sodium Benzoate | 0.01% | 0.01% | 0.01% | 0.01% |
| Sodium Hexametaphosphate | 0.09% | 0.09% | 0.09% | 0.09% |
| Calcium Disodium Edetate | 0.003% | 0.003% | 0.003% | 0.003% |
| Caffeine Anhydrous | 0.008% | 0.008% | 0.008% | 0.008% |
| Sodium Chloride | 0.001% | 0.001% | 0.001% | 0.001% |
| Acidulant | 0.1% | 0.1% | 0.1% | 0.1% |
| Liquid Quillaia Extract | 0.009% | 0.009% | 0.009% | 0.009% |
| Color Component | 0.2% | 0.2% | 0.2% | 0.2% |
| Caramel Color Component | 0.06% | 0.06% | 0.06% | 0.06% |
| Flavor A | 0.03% | 0.03% | 0.03% | 0.03% |
| Cola Flavor A | 0.11% | 0.11% | 0.11% | 0.11% |
| Cola Flavor B | 0.07% | 0.07% | 0.07% | 0.07% |
| Aspartame | 0% | 0.06% | 0.06% | 0.06% |
| Acesulfame Potassium | 0% | 0.009% | 0.009% | 0.009% |
| Erythritol | 0% | 0% | 1% | 2% |

The formulations were subjected to test A foam analysis using a Foam Scan analyzer (Teclis Scientific, France) in which compressed air was injected into a 50 mL sample at a flow rate of 400 mL/min to reach a foam volume maximum of 220 mL, and the foam volume was measured as a function of time.

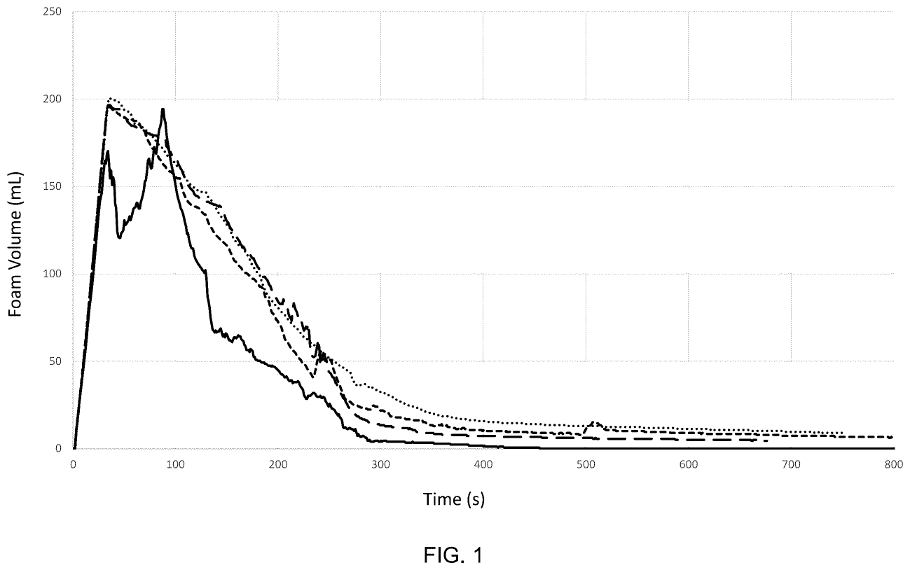

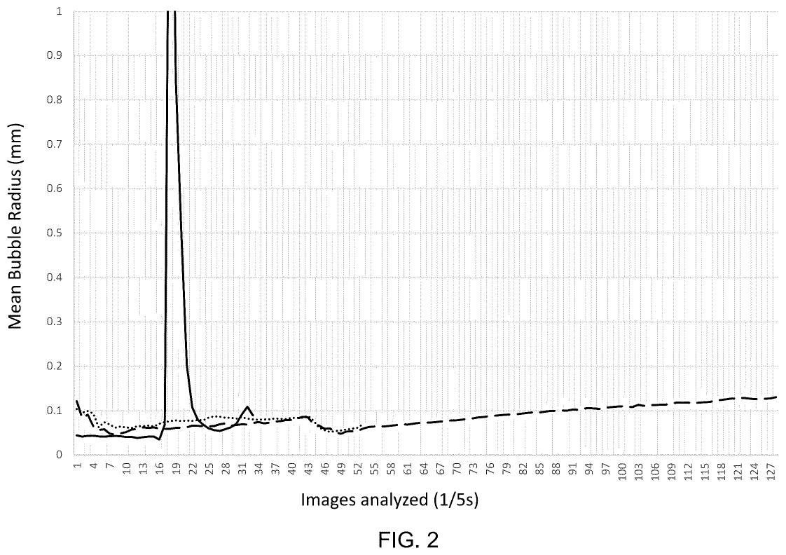

The foam volumes of Formulas 1-4 are shown in FIG. 1. The mean bubble size of Formulas 1, 2, and 4 are shown in FIG. 2.

### Example 2

The impact of quillaia extract on foam production was evaluated.

Beverage base formulations were prepared in accordance with the ingredients set forth in Table 2. A full sugar, comparative formulation (Formula 1) was prepared with high fructose corn syrup (HFCS). Four zero sugar, inventive formulations were prepared with APM, ASK, and erythritol either without (Formulas 5 and 6) or with quillaia extract (Formulas 7 and 8) and either with less flavoring (Formulas 5 and 7) or with more flavoring (Formulas 6 and 8).

TABLE 2

| | Formula 1 | Formula 5 | Formula 6 | Formula 7 | Formula 8 |
|---|---|---|---|---|---|
| Ingredient | (comparative) | (inventive) | (inventive) | (inventive) | (inventive) |
| Water | 79.86% | 98.22% | 98.22% | 98.22% | 98.22% |
| HFCS 55 @77.00 Brix | 12.67% | 0% | 0% | 0% | 0% |
| HFCS 42 @71.00 Brix | 6.77% | 0% | 0% | 0% | 0% |
| Potassium Sorbate | 0.01% | 0.01% | 0.01% | 0.01% | 0.01% |
| Sodium Benzoate | 0.01% | 0.01% | 0.01% | 0.01% | 0.01% |
| Sodium Hexametaphosphate | 0.09% | 0.09% | 0.09% | 0.09% | 0.09% |
| Calcium Disodium Edetate | 0.003% | 0.003% | 0.003% | 0.003% | 0.003% |
| Caffeine Anhydrous | 0.008% | 0.008% | 0.008% | 0.008% | 0.008% |
| Sodium Chloride | 0.001% | 0.001% | 0.001% | 0.001% | 0.001% |
| Acidulant | 0.1% | 0.1% | 0.1% | 0.1% | 0.1% |
| Liquid Quillaia Extract | 0.009% | 0% | 0% | 0.009% | 0.009% |
| Color Component | 0.2% | 0.2% | 0.2% | 0.2% | 0.2% |
| Caramel Color Component | 0.06% | 0.06% | 0.06% | 0.06% | 0.06% |
| Flavor A | 0.04% | 0% | 0.04% | 0% | 0.04% |
| Pepsi-Cola Flavor | 0.11% | 0.11% | 0.11% | 0.11% | 0.11% |
| Pepsi Flavor | 0.07% | 0.07% | 0.07% | 0.07% | 0.07% |
| Aspartame | 0% | 0.06% | 0.06% | 0.06% | 0.06% |
| Acesulfame Potassium | 0% | 0.009% | 0.009% | 0.009% | 0.009% |
| Erythritol | 0% | 1% | 1% | 1% | 1% |

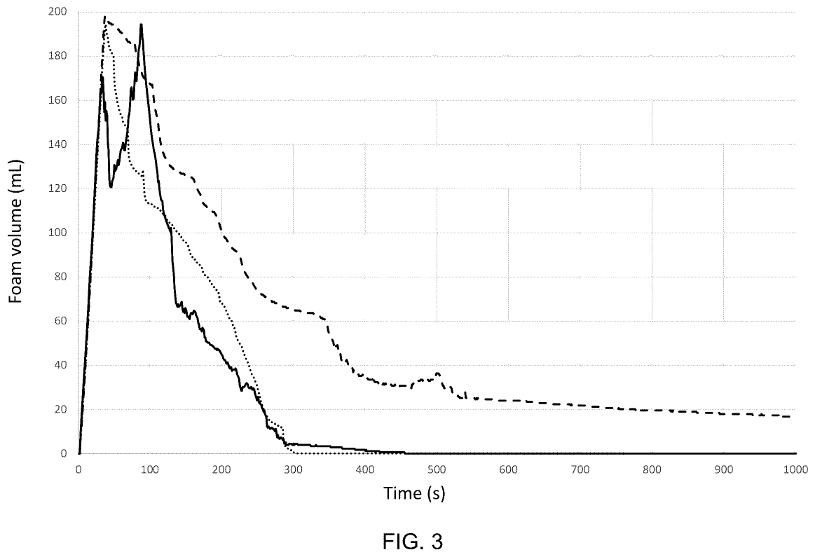

Fifty mL samples of the formulations were subjected to the same foam analysis set forth in Example 1. The foam volumes for Formulas 1, 5, and 7 are shown in FIG. 3. The quillaia extract and flavor helped to stabilize the foam in all cases. All of these variants generated more foam and had greater foam stability than the full-sugar formulation (Formula 1).

### Example 3

Formulas 1-4, as prepared in Example 1, were each used as a beverage base to form a ready to drink beverage. The beverage base was injected with carbon dioxide and then the beverage was disposed in an aluminum can containing a widget. Liquid nitrogen were added into the can, and the can was sealed to provide a ready to drink beverage. For testing, the ready to drink beverage was opened and poured into a drinking glass (e.g., a glass that holds 16 oz (about 473 mL) of liquid).

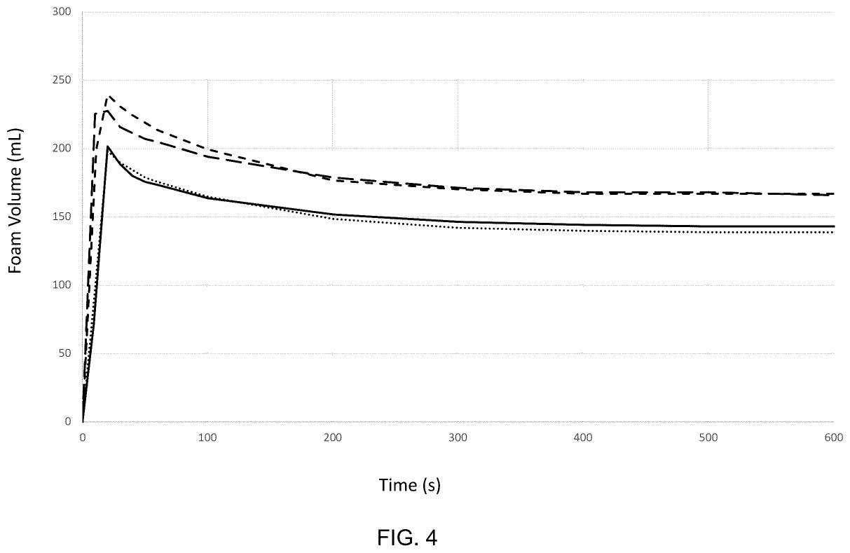

The foam volumes of Formulas 1-4 are shown in FIG. 4. Formulas 3 and 4 containing erythritol generated more foam but had a larger mean bubble size. However, each of Formulas 2-4 had stable foam heads over a 10-minute period, which was comparable to the foam head stability of the full-sugar formulation, Formula 1.

### Example 4

Reduced sweetener levels were evaluated in response to sensory feedback stating the beverage sweetness level of the zero sugar ready to drink beverages in Example 3 were high compared to the full sugar version.

Formulas 9-12 were prepared with the non-nutritive sweeteners listed in Table 4.

TABLE 4

| | | | Acesulfame |
|---|---|---|---|
| Formula | Erythritol | Aspartame | Potassium |
| 9 (inventive) | 0 wt % | 600 ppm | 90 ppm |
| 10 (inventive) | 1 wt % | 600 ppm | 90 ppm |
| 11 (inventive) | 0 wt % | 380 ppm | 110 ppm |
| 12 (inventive) | 0 wt % | 580 ppm | 40 ppm |

Using test B, it was observed that erythritol increased foam generation, but otherwise the foam stability looked similar between the reduced sweetener variant and the previous variants. Formula 11 had the greatest reduction in sweetener and had increased mean bubble size as compared to the formulas with higher sweetener levels. Formula 9, which contained erythritol, had the largest mean bubble size.

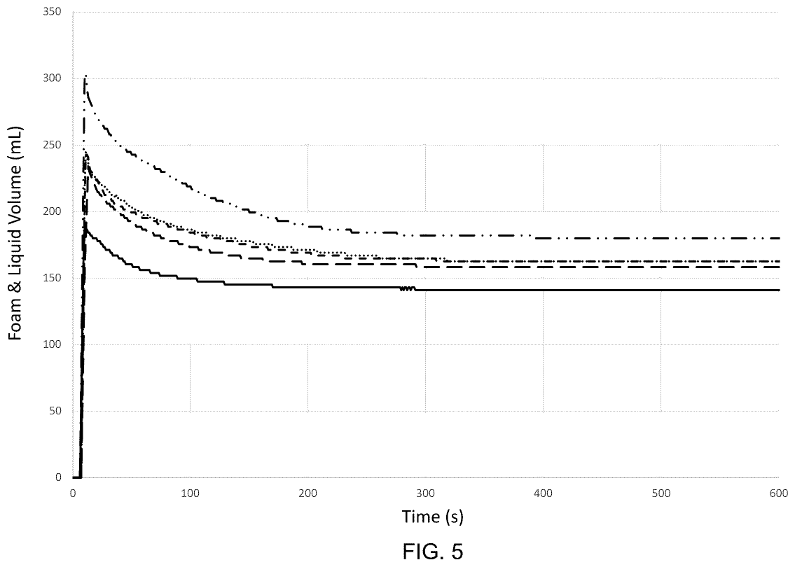

Next, test C was used, but due to issues with the parameter settings for the test, both the liquid and foam height are included FIG. 5. The results in FIG. 5 showed that all the beverages had similar foam generation volumes and rates, but the foam stabilities were different. The beverage with 1 wt % erythritol had increased foam stability, and the beverages with a lower concentration of non-nutritive sweeteners had a relatively lower foam stability. It was observed that aspartame created more foam that was longer lasting and with a smaller mean bubble size. If the aspartame content is reduced, a second non-nutritive sweetener, such as erythritol, can be added to maintain a long-lasting foam head. Notably, the foam stability of these zero sugar formulas was better than the full sugar control formula (Formula 1).

### Example 5

Formulas with reduced sweetener levels were evaluated.

Formulas 13 and 14 were prepared with the non-nutritive sweeteners listed in Table 5. Formula 13 comprised 350 ppm aspartame, 90 ppm acesulfame potassium, and no erythritol. Formula 14 comprised 350 ppm aspartame, 90 ppm acesulfame potassium, and erythritol.

TABLE 5

| | Formula 13 | Formula 14 |
|---|---|---|
| Ingredient | (inventive) | (inventive) |
| Water | 98.05% | 98.0485% |
| Potassium Sorbate | 0.01% | 0.01% |
| Sodium Benzoate | 0.01% | 0.01% |
| Sodium Hexametaphosphate | 0.09% | 0.09% |
| Calcium Disodium Edetate | 0.003% | 0.003% |
| Sodium Chloride | 0.001% | 0.001% |
| Aspartame | 0.04% | 0.04% |
| Acesulfame Potassium | 0.009% | 0.009% |
| Flavor C | 0.006% | 0.006% |
| Flavor D | 0.02% | 0.02% |
| Caffeine | 0.008% | 0.008% |
| Flavor | 0.05% | 0.05% |
| Acidulant F10572 | 0.11% | 0.11% |
| Liquid Quillaia Extract | 0.01% | 0.01% |
| Color component F5982 | 0.21% | 0.21% |
| Caramel Color Component F11011 | 0.06% | 0.06% |
| Flavor A | 0.04% | 0.04% |
| Pepsi Flavor 35005*26 | 0.12% | 0.12% |
| Pepsi Flavor 35009*70 | 0.08% | 0.08% |
| Erythritol | 0% | 1.06% |

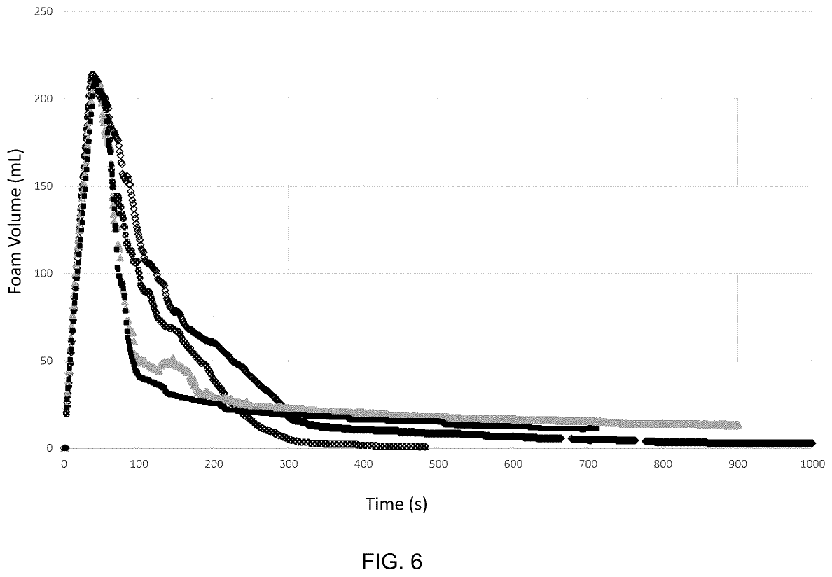

FIG. 6 shows the foam generation at 40° C. and foam collapse speed after compressed air was forced into the beverage at 400 mL/min until a maximum height of ˜220 mL or a customized maximum foam height was reached. The foam volumes of Formulas 13 and 14, along with Nitro PEPSI® (full sugar; comparative) and Nitro PEPSI® Vanilla (full sugar; comparative) are shown in FIG. 6.

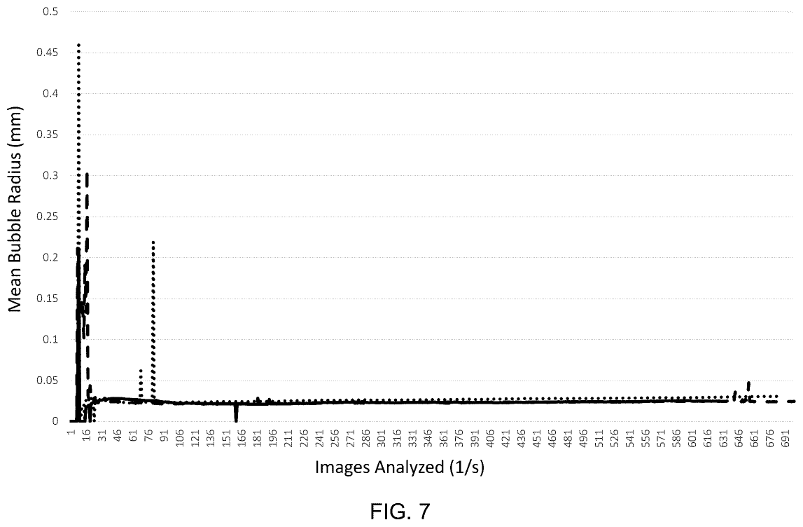

The mean bubble size of Nitro PEPSI® (full sugar; comparative) and Nitro PEPSI® Vanilla (full sugar; comparative) and Formula 13 are shown in FIG. 7.

### Example 6

Formulas with natural non-nutritive sweeteners were evaluated.

Formulas 15-19 were prepared with the non-nutritive sweeteners listed in Table 6. Formula 15 was a base formula and comprised no sweetener. The base formula was used to prepare: Formula 16 comprising 400 ppm Reb M 99, Formula 17 comprising 400 ppm Reb A 97, Formula 18 comprising 400 ppm Reb D 95, and Formula 19 comprising 400 ppm monk fruit extract.

TABLE 6

| | Formula 15 | Formula 16 | Formula 17 | Formula 18 | Formula 19 |
|---|---|---|---|---|---|
| Ingredient | (base formula) | (inventive) | (inventive) | (inventive) | (inventive) |
| Water | 99.22% | 99.22% | 99.22% | 99.22% | 99.22% |
| Potassium Sorbate | 0.01% | 0.01% | 0.01% | 0.01% | 0.01% |
| Sodium Benzoate | 0.01% | 0.01% | 0.01% | 0.01% | 0.01% |
| Sodium Hexametaphosphate | 0.09% | 0.09% | 0.09% | 0.09% | 0.09% |
| Calcium Disodium Edetate | 0.003% | 0.003% | 0.003% | 0.003% | 0.003% |
| Sodium Chloride | 0.01% | 0.01% | 0.01% | 0.01% | 0.01% |
| Flavor C | 0.006% | 0.006% | 0.006% | 0.006% | 0.006% |
| Flavor D | 0.02% | 0.02% | 0.02% | 0.02% | 0.02% |
| Caffeine | 0.01% | 0.01% | 0.01% | 0.01% | 0.01% |
| Flavor B | 0.05% | 0.05% | 0.05% | 0.05% | 0.05% |
| Phosphoric acid 80% | 0.06% | 0.06% | 0.06% | 0.06% | 0.06% |
| Tartaric Acid | 0.008% | 0.008% | 0.008% | 0.008% | 0.008% |
| Liquid Quillaia Extract | 0.01% | 0.01% | 0.01% | 0.01% | 0.01% |
| Color component F5982 | 0.21% | 0.21% | 0.21% | 0.21% | 0.21% |
| Caramel Color Component F11011 | 0.06% | 0.06% | 0.06% | 0.06% | 0.06% |
| Flavor A | 0.04% | 0.04% | 0.04% | 0.04% | 0.04% |
| Pepsi Flavor 35005*85 | 0.11% | 0.11% | 0.11% | 0.11% | 0.11% |
| Pepsi Flavor 35009*70 | 0.08% | 0.08% | 0.08% | 0.08% | 0.08% |
| Reb M 99 | 0% | 0.04% | 0% | 0% | 0% |
| Reb A 97 | 0% | 0% | 0.4% | 0% | 0% |
| Reb D 95 | 0% | 0% | 0% | 0.4% | 0% |
| Monk Fruit | 0% | 0% | 0% | 0% | 0.4% |

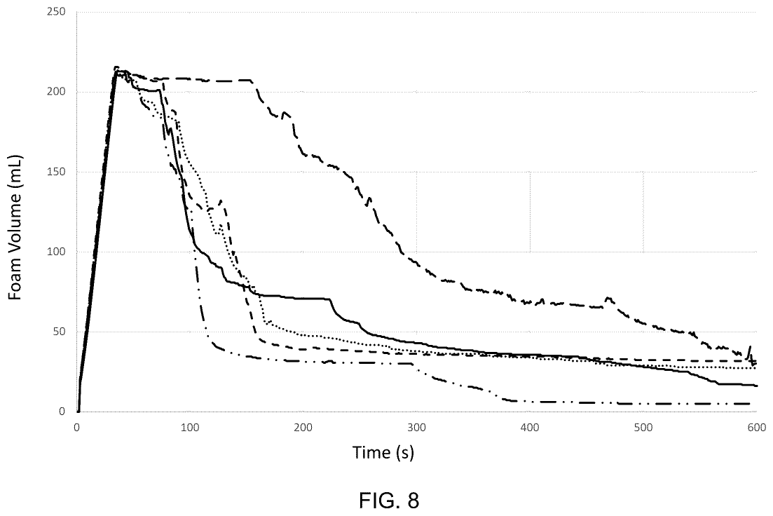

Fifty mL samples of Formulas 15-19 were subjected to the foam analysis of test A. The foam volumes for Formulas 15-19 are shown in FIG. 8. Each formula in FIG. 8 reached the maximum foam height allowed by the instrument in almost the exact same amount of time, but the foam stability differed based on the natural non-nutritive sweeteners present.

The control, which contained no sweeteners, as a reference point for comparison. The addition of Reb M 99 and Reb A 97 resulted in similar overall foam collapse profiles, but they differed in how the foam collapsed in the middle of testing from the 100 to 300 second mark. The formula with Reb D 95 showed an increased foam collapse rate in the later stages of the foam life after ˜100 seconds. The difference between the control and the beverage base with Reb D 95 was 30-40 mL lower at similar time points. The addition of monk fruit extract helped to stabilize the foam against collapse. The beverage with monk fruit extract maintained a foam height close to the maximum foam height allowed (˜220 mL) for almost two minutes. After that, it maintained a larger foam head than any of the other variants tested, providing significant foam stability.

Bubble size was determined by injecting compressed air through 50 mL of the test beverage and capturing images of the resulting foam by a camera calibrated to analyze bubble size. Close-up images of the bubbles within the foam were captured at a rate of 1 image per second. Software provided by Teclis-Scientific (“CSA”) calculated both mean bubble size and bubble count for each image taken over the time of the experiment.

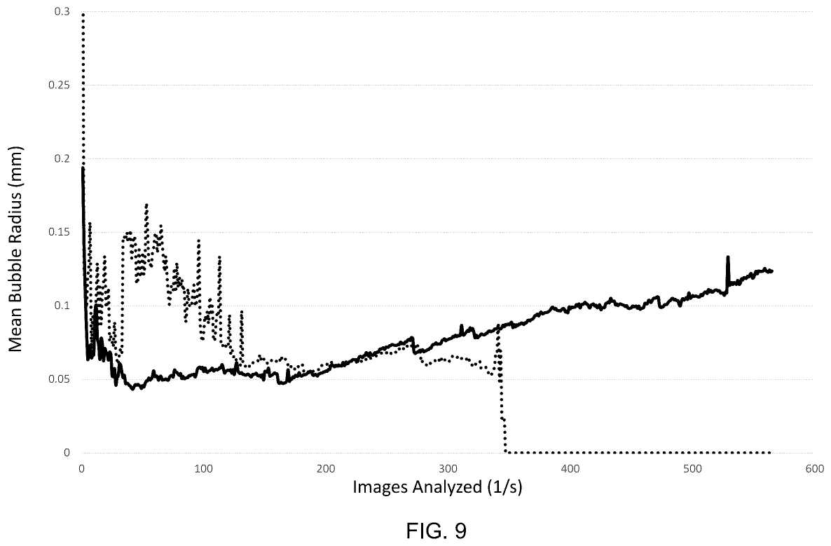

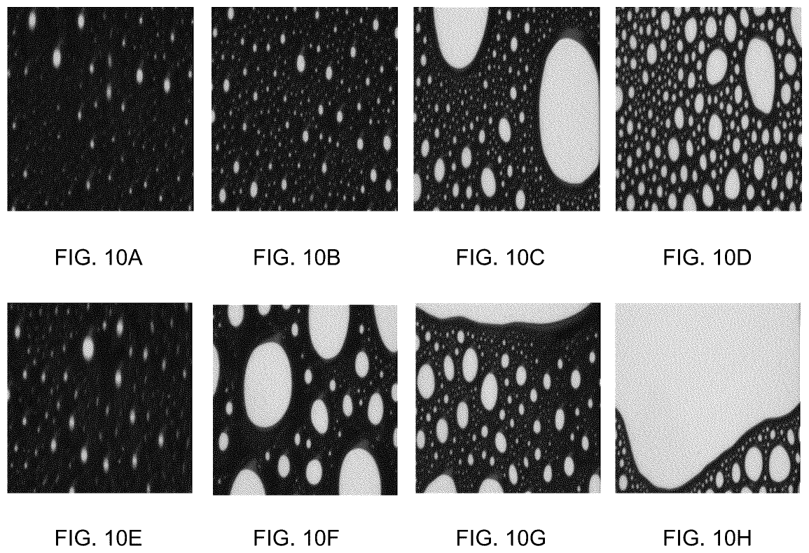

The mean bubble size of Formula 15 (base; control) and Formula 16 (400 ppm Reb M 99) are shown in FIG. 9. The micrographs for the bubble counts of FIG. 9 are shown in FIGS. 10A-10H. FIGS. 10A-10H show the mean bubble size of each image analyzed during the test. Images were captured at a rate of one per second, with each image number corresponding to the number of seconds from start time that the image was taken. Formula 15 (base control): image #24 (FIG. 10A), image #70 (FIG. 10B), image #150 (FIG. 10C), and image #315 (FIG. 10D). Formula 16 (base+400 ppm Reb M 99): image #24 (FIG. 10E), image #70 (FIG. 10F), image #150 (FIG. 10G), and image #315 (FIG. 10H). The camera zoomed in on the foam and each captured image contained anywhere from one to hundreds of bubbles. The bubble size was interpreted by the computer software, and the average of the bubble size per image are shown over time. The bubble size of Formula 15 was lower on average in the beginning of the test, up until 200 seconds where the bubble size steadily rose above that of Formula 16. In the beginning of the test, the mean bubble size of the base with Reb M 99 can reach up to three times the mean size of the bubbles of the base with no sweeteners at the same time point.

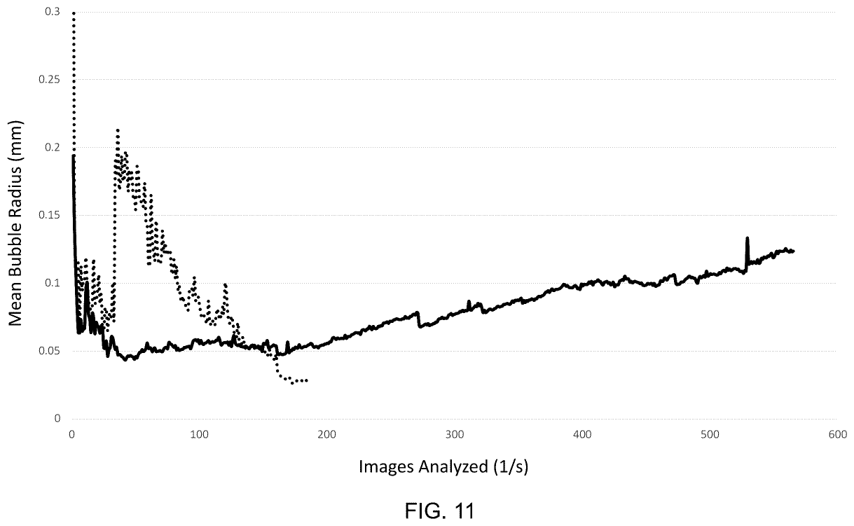

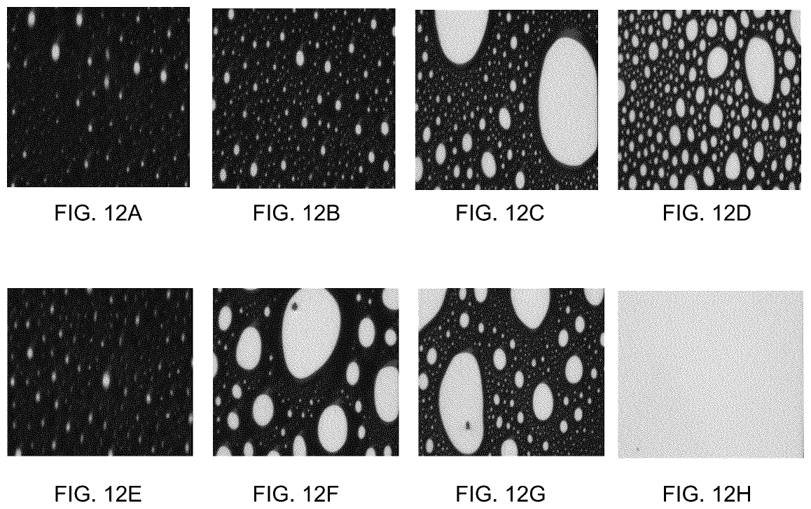

The mean bubble size of Formula 15 (base; control) and Formula 17 (400 ppm Reb A 97) are shown in FIG. 11. The micrographs for the bubble counts of FIG. 11 are shown in FIGS. 12A-12H. FIGS. 12A-12H show the mean bubble size of each image analyzed during the test. Images were captured at a rate of one per second, with each image number corresponding to the number of seconds from start time that the image was taken. Formula 15 (base control): image #24 (FIG. 12A), image #70 (FIG. 12B), image #150 (FIG. 12C), and image #315 (FIG. 12D). Formula 17 (base+400 ppm Reb A 97): image #24 (FIG. 12E), image #70 (FIG. 12F), image #150 (FIG. 12G), and image #315 (FIG. 12H). The bubble size profile of Formula 17 mimicked that of Formula 16, but the mean bubble size was even larger on average, peaking above 0.2 mm.

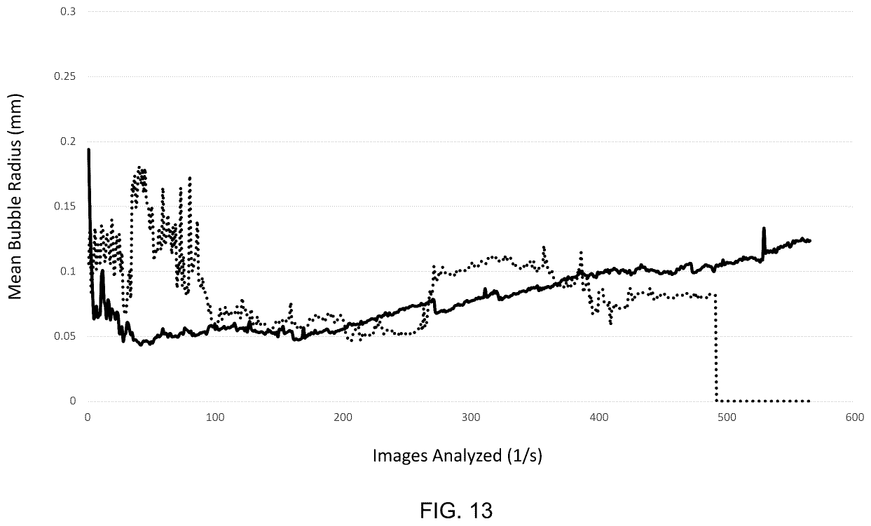

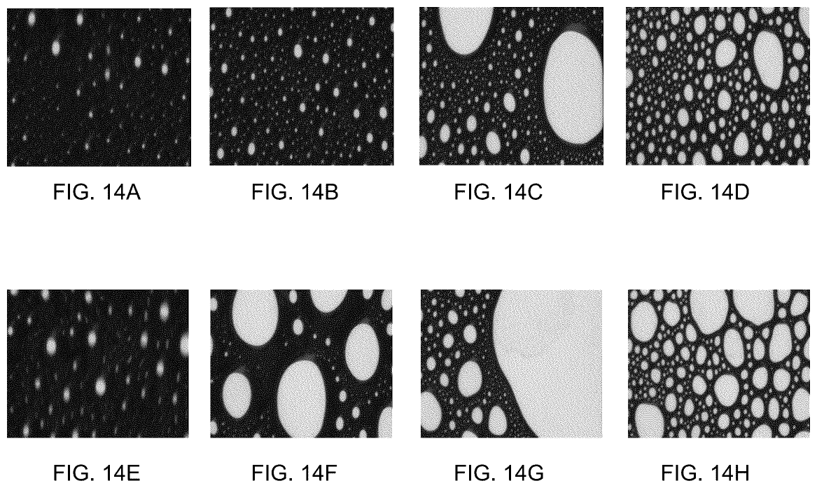

The mean bubble size of Formula 15 (base; control) and Formula 18 (400 ppm Reb D 95) are shown in FIG. 13. The micrographs for the bubble counts of FIG. 13 are shown in FIGS. 14A-14H. FIGS. 14A-14H show the mean bubble size of each image analyzed during the test. Images were captured at a rate of one per second, with each image number corresponding to the number of seconds from start time that the image was taken. Formula 15 (base control): image #24 (FIG. 14A), image #70 (FIG. 14B), image #150 (FIG. 14C), and image #315 (FIG. 14D). Formula 18 (base+400 ppm Reb D 95) of image #24 (FIG. 14E), image #70 (FIG. 14F), image #150 (FIG. 14G), and image #315 (FIG. 14H). Like the other stevia variants, the mean bubble size was larger for the first 100 seconds+ and then reduced to a smaller size where the mean bubble size stabilized. After 300 seconds, the mean bubble size increased as the liquid in the foam drained, the bubbles coalesced, and the larger bubbles in the top of the foam dropped down into the camera frame. See image 315 in FIG. 14H.

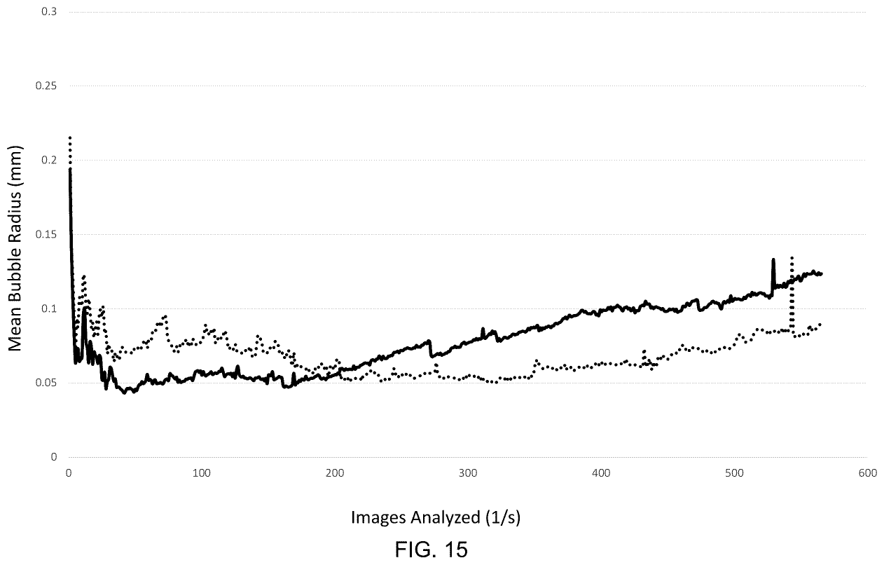

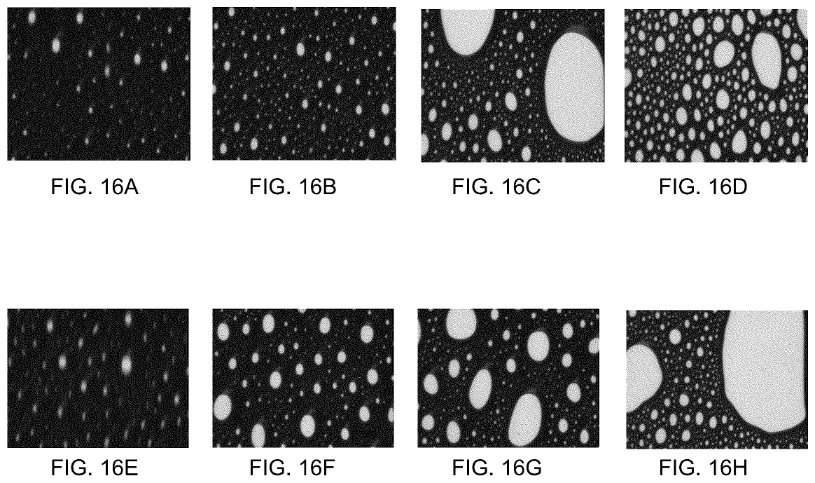

The mean bubble size of Formula 15 (base; control) and Formula 19 (400 ppm monk fruit extract) are shown in FIG. 15. The micrographs for the bubble counts of FIG. 15 are shown in FIGS. 16A-16H. FIGS. 16A-16H show the mean bubble size of each image analyzed during the test. Images were captured at a rate of one per second, with each image number corresponding to the number of seconds from start time that the image was taken. Formula 15 (control): image #24 (FIG. 16A), image #70 (FIG. 16B), image #150 (FIG. 16C), and image #315 (FIG. 16D). Formula 19 (base+400 ppm monk fruit): image #24 (FIG. 16E), image #70 (FIG. 16F), image #150 (FIG. 16G), and image #315 (FIG. 16H). The mean bubble size of Formula 19 was slightly larger in the beginning (˜0.02 mm) than Formula 15, but then there was an inflection point at around 200 seconds where the Formula 19 bubbles remained small on average and the Formula 15 bubbles continued to increase in size.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

1. A beverage base comprising
water;
a nutritive sweetener in an amount of 12 Brix or less, a non-nutritive sweetener, or a combination of both; and
at least one multifunctional component selected from the group consisting of aspartame, acesulfame potassium, sucralose, quillaia extract, class 1 caramel, emulsifying pectin, a flavoring, and any combination thereof,
wherein the viscosity of the beverage base at 21.1° C. (70° F.) is about 1.01 to about 1.8 cP; and
wherein the beverage base has a property that when a 50 mL sample of the beverage base is subjected to a foam analyzer and air is injected into the sample at a flow rate of 400 mL/min, the beverage base holds a foam volume of about 20 mL or more for 8 min or longer.

2. The beverage base of claim 1, wherein the multifunctional component comprises quillaia extract, class 1 caramel, or a combination thereof.

3. The beverage base of claim 1, wherein the multifunctional component comprises aspartame, acesulfame potassium, or a combination thereof.

4. The beverage base of claim 1, wherein the nutritive sweetener is sucrose or high fructose corn syrup.

5. The beverage base of claim 4, wherein the nutritive sweetener is present in an amount of 11 Brix or less.

6. The beverage base of claim 1, wherein a non-nutritive sweetener is present.

7. The beverage base of claim 6, wherein the non-nutritive sweetener is natural or synthetic.

8. The beverage base of claim 6, wherein the non-nutritive sweetener is a steviol glycoside, monk fruit extract, aspartame, acesulfame potassium, a sugar alcohol, or any combination thereof.

9. The beverage base of claim 8, wherein the steviol glycoside is stevioside, dulcoside, rebaudioside A, rebaudioside B, rebaudioside C, rebaudioside D, rebaudioside E, rebaudioside F, rebaudioside M, or any combination thereof.

10. (canceled)

11. The beverage base of claim 8, wherein the non-nutritive sweetener is monk fruit extract, aspartame, acesulfame potassium, rebaudioside A, rebaudioside D, rebaudioside M, or any combination thereof.

12. (canceled)

13. (canceled)

14. The beverage base of claim 6, further comprising erythritol.

15. The beverage base of claim 6, wherein the non-nutritive sweetener is present in a total amount from about 0.001 to about 3 wt %.

16. The beverage base of claim 1, further comprising at least one additive.

17. The beverage base of claim 16, wherein the at least one additive is selected from the group consisting of caffeine, an acidulant, a salt, a taste-improving additive, a preservative, an antioxidant, a flavoring, a color, and any combination thereof.

18. The beverage of claim 17, wherein the acidulant is phosphoric acid, citric acid, malic acid, tartaric acid, lactic acid, fumaric acid, ascorbic acid, gluconic acid, succinic acid, maleic acid, adipic acid, cinnamic acid, glutaric acid, carbonic acid, or any combination thereof.

19. The beverage base of any one of claim 17, wherein the preservative is a benzoate, a propionate, a sorbate, a citrate, an edetate, a polyphosphate, or any combination thereof.

20. The beverage base of claim 17, wherein the antioxidant is a vitamin, a polyphenol, citric acid, oxalic acid, glutamic acid, aspartic acid, phosphoric acid, polyphosphoric acid, a phosphonate, ethylenediaminetetraacetic acid, diethylenetriaminepentaacetic acid, hydroxyethylethylenediaminetriacetic acid, iminodisuccinic acid, any salt thereof, butylated hydroxytoluene (BHT), tert-butylhydroquinone (TBHQ), dehydroacetic acid, dimethyldicarbonate, ethoxyquin, heptylparaben, or any combination thereof.

21. The beverage base of claim 17, wherein the flavoring is citrus, cola, vanilla, root beer, fruit, or any combination thereof.

22. The beverage base of claim 1, wherein the beverage base has a property that a foam volume maximum of about 200 to about 230 mL is provided when a 50 mL sample of the beverage base is subjected to a foam analyzer and air is injected into the sample at a flow rate of 400 mL/min.

23. The beverage base of claim 1, wherein the beverage base holds a foam volume of about 30 mL or more for about 8 min or longer.

24. A ready to drink beverage comprising the beverage base of claim 1 and at least one dissolved gas.

25. The ready to drink beverage of claim 24, wherein the at least one dissolved gas comprises carbon dioxide, nitrogen, nitrous oxide, oxygen, compressed air, or a combination thereof.

26. The ready to drink beverage of claim 24, wherein the at least one dissolved gas comprises a combination of carbon dioxide and nitrogen gas.

27. The ready to drink beverage of claim 26, wherein the carbon dioxide and nitrogen gas are in a volume ratio of about 90:10 to about 10:90.

28. (canceled)

29. The ready to drink beverage of claim 24, wherein the ready to drink beverage is disposed in a sealed container.

30. The ready to drink beverage of any claim 29, wherein the sealed container further comprises a widget.

31. The ready to drink beverage of claim 29, wherein the ready to drink beverage has a foam with a mean bubble radius of about 0.005 to about 0.1 mm for at least 100 sec after being unsealed and poured into a drinking glass.

32. (canceled)
